(19) United States
(12) Patent Application Publication
(10) Pub. No.: US 2025/0308730 A1
(43) Pub. Date: Oct. 2, 2025

(54) CLAMP GUARD

(71) Applicant: Hubbell Incorporated, Shelton, CT (US)

(72) Inventor: Paul Alfaro, Orange, CA (US)

(21) Appl. No.: 19/090,952

(22) Filed: Mar. 26, 2025

Related U.S. Application Data
(60) Provisional application No. 63/569,935, filed on Mar. 26, 2024.

(51) Int. Cl. H01B 17/16; H02G 7/00

(52) U.S. Cl. CPC H01B 17/16; H02G 7/00

(57) ABSTRACT

A clamp guard includes a first body, a second body, a biasing member, and a first gate. The first body has a first lower end and a first internal cavity for at least partially receiving the electrical component. The second body is movably coupled to the first body and has a second lower end and a second internal cavity for at least partially receiving the electrical component. The biasing member is connected between the first body and the second body. The first gate is coupled to the first body proximate to the first lower end and is movable between a first gate position and a second gate position. The second body is movable relative to the first body against a bias of the biasing member between a closed position and an open position. The first gate is movable coupled to the first body proximate to the first lower end.

### CROSS-REFERENCE TO RELATED APPLICATION

This application claims the benefit of U.S. Provisional Application No. 63/569,935, filed Mar. 26, 2024, the entire contents of which are included by reference herein in its entirety.

### FIELD

The present disclosure relates to a clamp. More particularly, the present disclosure relates to a clamp guard for use with components connected to an electrical conductor.

### BACKGROUND

Electrical components (e.g., power lines and other energized elements) are built across different environments to bring power to consumers and businesses. To convey electrical energy to consumers across wide and diverse areas, energized components need to be built within many environments, some of may be undeveloped or otherwise include an abundance of wildlife. Wildlife may be interested in these structures and not realize the dangers posed by the energized elements. Additionally, or alternatively, wildlife may attempt to interact with the components in ways that are harmful to the life of the component.

To keep wildlife safe and/or to extent the lifespan of the electrical components, linesman or other technicians may install guards at or near the energized elements. These guards may assist in providing a barrier between the animals' habitat and the energized elements, thereby reducing the animals that are inadvertently harmed and the components from being damaged. The guards also help to maintain the integrity of the system by limiting shorts or other electrical failures caused when animals interact with the energized elements.

Typical guards require the linesman or technician to physically close the guard around the desired element. Additionally, the guard may not fully enclose the element and may still provide pathways for wildlife to enter and interact with the component.

### SUMMARY

Various embodiments of the present disclosure can overcome various of the aforementioned and other disadvantages associated with known clamps and offer new advantages as well.

According to one aspect of various embodiments of the present disclosure there is provided a clamp guard for selectively limiting ingress to an internal cavity of the clamp guard.

According to one aspect of various embodiments of the present disclosure there is provided a clamp guard having an open bottom and a gate connected proximate to the open bottom. The gate can be movable between an open and closed position to selectively provide access to an internal cavity of the clamp guard.

According to one aspect of various embodiments of the present disclosure there is provided a clamp guard with a first body and second body movable relative to the first body against a bias of a biasing member.

According to one aspect of various embodiments of the present disclosure there is provided a clamp guard having an open bottom and a gate connected proximate to the open bottom. The gate includes a latch that selectively engages a housing of the clamp guard to limit access to an internal volume of the clamp guard.

According to one aspect of various embodiments of the present disclosure there is provided a clamp guard with a first body and second body movable relative to the first body. The first body includes a first hook to selectively connect to a second latch in the second body. The second body includes a second hook to selectively connect to a first latch in the first body.

According to one aspect of various embodiments of the present disclosure there is provided a clamp guard for securing an electrical component. The clamp guard includes a first body, a second body, a biasing member, and a first gate. The first body has a first lower end and a first internal cavity for at least partially receiving the electrical component. The second body is movably coupled to the first body and has a second lower end and a second internal cavity for at least partially receiving the electrical component. The biasing member is connected between the first body and the second body. The first gate is coupled to the first body proximate to the first lower end. The second body is movable relative to the first body against a bias of the biasing member between a closed position where the second lower end is adjacent to the first lower end and the first internal cavity and the second internal cavity form a volume, and an open position where the second lower end is spaced apart from the first lower end. The first gate is movable coupled to the first body proximate to the first lower end. The first gate can move between a first gate position that limits access to the first internal cavity and a second gate position that permits access to the first internal cavity.

According to another aspect of various embodiments of the present disclosure, there is provided a clamp guard for securing an electrical component. The clamp guard includes a first body, a second body, a first gate, and a second gate. The first body has a first lower end and a first internal cavity for at least partially receiving the electrical component. The second body is movably coupled to the first body and has a second lower end and a second internal cavity for at least partially receiving the electrical component. The first gate is coupled to the first body proximate to the first lower end. The second gate is coupled to the second body proximate to the second lower end. The second body is movable relative to the first body between a closed position where the second lower end is adjacent to the first lower end and the first internal cavity and the second internal cavity form a volume, and an open position where the second lower end is spaced apart from the first lower end. The first gate is movable coupled to the first body proximate to the first lower end. The first gate can move between a first gate position that limits access to the first internal cavity and a second gate position that permits access to the first internal cavity. The second gate is movable coupled to the second body proximate to the second lower end. The second gate can move between a third gate position that limits access to the second internal cavity and a fourth gate position that permits access to the second internal cavity.

According to another aspect of various embodiments of the present disclosure, there is provided a clamp guard for securing an electrical component. The clamp guard includes a first body, a second body, a biasing member, an opening extending from the first body, a first gate, and a second gate. The first body has a first lower end and a first internal cavity for at least partially receiving the electrical component. The second body movably coupled to the first body and has a second lower end and a second internal cavity for at least partially receiving the electrical component. The biasing member is connected between the first body and the second body. The first gate is coupled to the first body proximate to the first lower end. The second gate is coupled to the second body proximate to the second lower end. The second body is movable relative to the first body against a bias of the biasing member between a closed position where the second lower end is adjacent to the first lower end and the first internal cavity and the second internal cavity form a volume, and an open position where the second lower end is spaced apart from the first lower end. The opening can receive a tool for moving the second body relative to the first body.

According to another aspect of various embodiments of the present disclosure, there is provided a clamp guard for securing an electrical component. The clamp guard includes a first body, a second body, a first gate, and a second gate. The first body has a first lower end and a first internal cavity for at least partially receiving the electrical component. The second body is movably coupled to the first body and has a second lower end and a second internal cavity for at least partially receiving the electrical component. The first gate is coupled to the first body proximate to the first lower end. The second gate is coupled to the second body proximate to the second lower end. The second body is movable relative to the first body between a closed position where the second lower end is adjacent to the first lower end and the first internal cavity and the second internal cavity form a volume, and an open position where the second lower end is spaced apart from the first lower end. The first gate includes a first latch and the second gate includes a second latch. The first housing includes a first complementary latch and the second housing includes a second complementary latch. The first latch can engage the second complementary latch and the second latch can engage the first complementary latch. Engagement of the first latch to the second latch can limit movement of the second body relative to the first body.

According to another aspect of various embodiments of the present disclosure, there is provided a clamp guard for securing an electrical component. The clamp guard includes a first body, a second body, and a first gate. The first body has a first lower end and a first internal cavity for at least partially receiving the electrical component. The second body is movably coupled to the first body and has a second lower end and a second internal cavity for at least partially receiving the electrical component. The first gate is coupled to the first body proximate to the first lower end. The first gate includes a lock movable relative to the first gate between a first lock position and a second lock position. The second body is movable relative to the first body between a closed position where the second lower end is adjacent to the first lower end and the first internal cavity and the second internal cavity form a volume, and an open position where the second lower end is spaced apart from the first lower end. The first gate is movable coupled to the first body proximate to the first lower end. The first gate can move between a first gate position that limits access to the first internal cavity and a second gate position that permits access to the first internal cavity. The lock is engaged with the first body in the first lock position to limit movement of the first gate between the first gate position and the second gate position.

According to another aspect of various embodiments of the present disclosure, there is provided a method of accessing an electrical component provided within a clamp guard. The method includes moving a first body relative to a second body to an open position and positioning the electrical component within an interior cavity of the first body. The method also includes moving the first body relative to the second body to a closed position where the electrical component is at least partially enclosed within the interior cavity. The method further includes moving a gate coupled to the first body between a first gate position that limits access to the interior cavity and a second gate position that permits access to the interior cavity. The method further includes moving a lock on the gate between a first locked position and a second locked position. In the first locked position, the gate is limited from moving between the first gate position and the second gate position. In the second locked position, the gate is movable between the first gate position and the second gate position.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is a top perspective view of a clamp guard according to a first example.

FIG. 2 is a bottom perspective view of the clamp guard of FIG. 1.

FIG. 3 is a front view of the clamp guard of FIG. 1.

FIG. 4 is a side view of the clamp guard of FIG. 1.

FIG. 5 is a top view of the clamp guard of FIG. 1.

FIG. 6 is a bottom view of the clamp guard of FIG. 1.

FIG. 7 is a cross-sectional view of the clamp guard of FIG. 1, viewed along section 7--7.

FIG. 8 is a perspective view of a first body of the clamp guard of FIG. 1.

FIG. 9 is a perspective view of a gate of the clamp guard of FIG. 1.

FIG. 10 is a perspective view of the clamp guard of FIG. 1 with a first half rotated into a second position.

FIG. 11 is a side view of the clamp guard of FIG. 10.

FIG. 12 is a front view of the clamp guard of FIG. 10.

FIG. 13 is a bottom view of the clamp guard of FIG. 1 with a gate rotated into an open position.

FIG. 14 is a cross-sectional view of the clamp guard of FIG. 13, viewed along section 14--14.

FIG. 15 is a top perspective view of a clamp guard according to a second example.

FIG. 16 is a bottom perspective view of the clamp guard of FIG. 15.

FIG. 17 is a front view of the clamp guard of FIG. 15.

FIG. 18 is a side view of the clamp guard of FIG. 15.

FIG. 19 is a top view of the clamp guard of FIG. 15.

FIG. 20 is a bottom view of the clamp guard of FIG. 15.

FIG. 21 is a cross-sectional view of the clamp guard of FIG. 15, viewed along section 21--21.

FIG. 22 is a cross-sectional view of the clamp guard of FIG. 15, viewed along section 22--22.

FIG. 23 is a perspective view of the clamp guard of FIG. 15 with a first half rotated into a second position.

FIG. 24 is a side view of the clamp guard of FIG. 23.

FIG. 25 is a side view of the clamp guard of FIG. 23.

FIG. 26 is a bottom view of the clamp guard of FIG. 15 with a gate rotated into an open position.

FIG. 27 is a cross-sectional view of the clamp guard of FIG. 15, viewed along section 21--21 with the gate moved to an open position.

FIG. 28 is a perspective view of a first body of the clamp guard of FIG. 15.

FIG. 29 is a top perspective view of a clamp guard according to a third example.

FIG. 30 is a bottom perspective view of the clamp guard of FIG. 29.

FIG. 31 is a side view of the clamp guard of FIG. 29.

FIG. 32 is a top view of the clamp guard of FIG. 29.

FIG. 33 is a bottom view of the clamp guard of FIG. 29.

FIG. 34 is a perspective view of the clamp guard of FIG. 29 in an opened position.

FIG. 35 is a cross-sectional view of the clamp guard of FIG. 29, viewed along section 35--35.

FIG. 36 is a perspective view of a gate of the clamp guard of FIG. 29.

FIG. 37 is a perspective view of a lock of the gate of FIG. 36.

FIG. 38 is a front view of the gate of FIG. 36.

FIG. 39 is a front view of the gate of FIG. 36, with the lock in a first position.

FIG. 40 is a front view of the gate of FIG. 36, with the lock in a second position.

FIG. 41 is perspective view of the gate positioned in a first position with the lock in the first locked position.

FIG. 42 is perspective view of the gate positioned in a second position with the lock in the second locked position.

### DETAILED DESCRIPTION

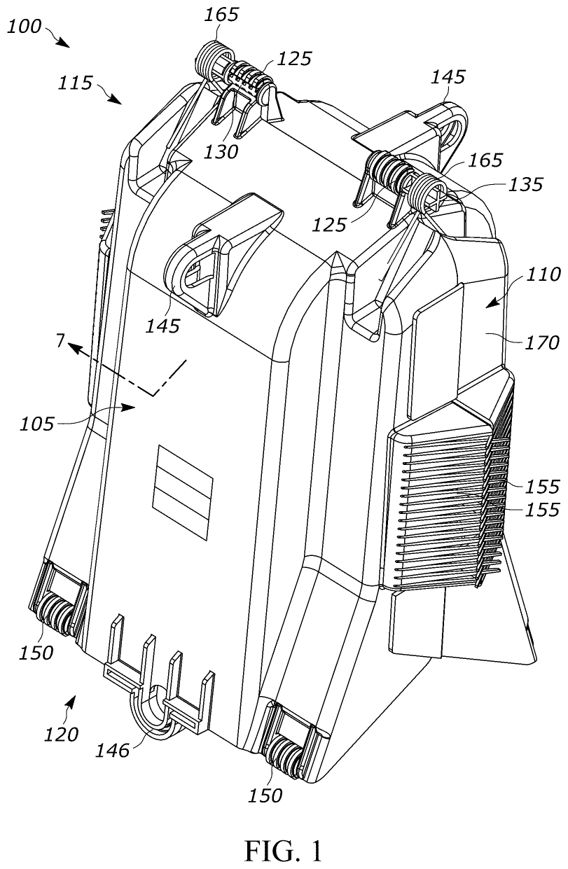

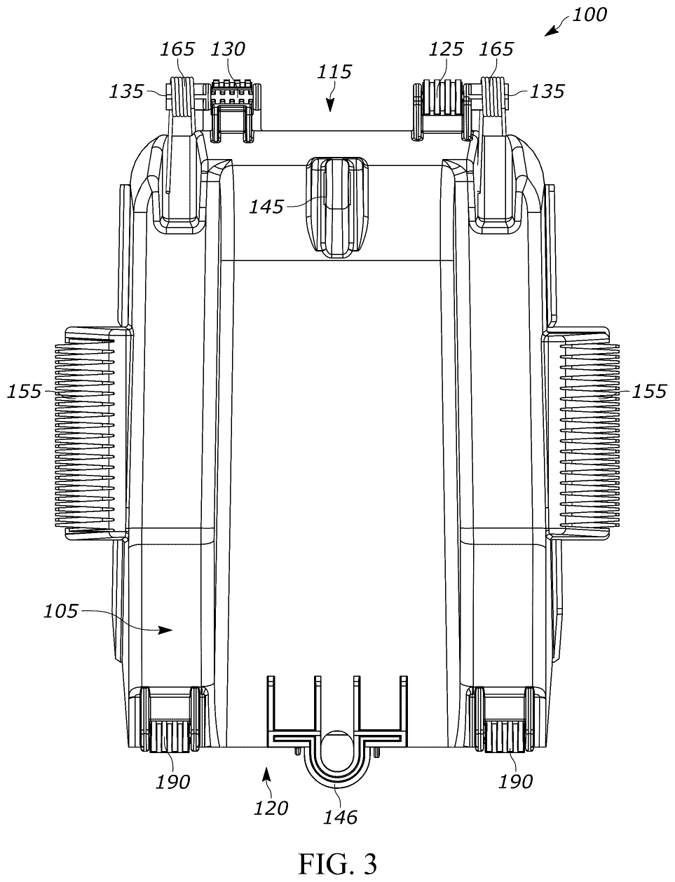

FIGS. 1 to 6 illustrate a housing or clamp guard 100 that may be used to house electrical components. Specifically, the clamp guard 100 may limit access to energized components from avian and climbing animals by creating a physical barrier to impede access.

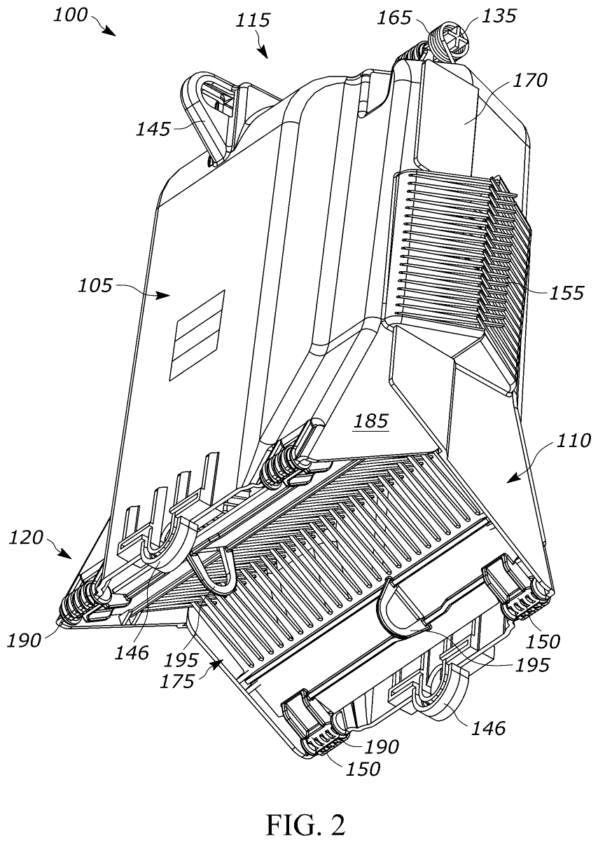

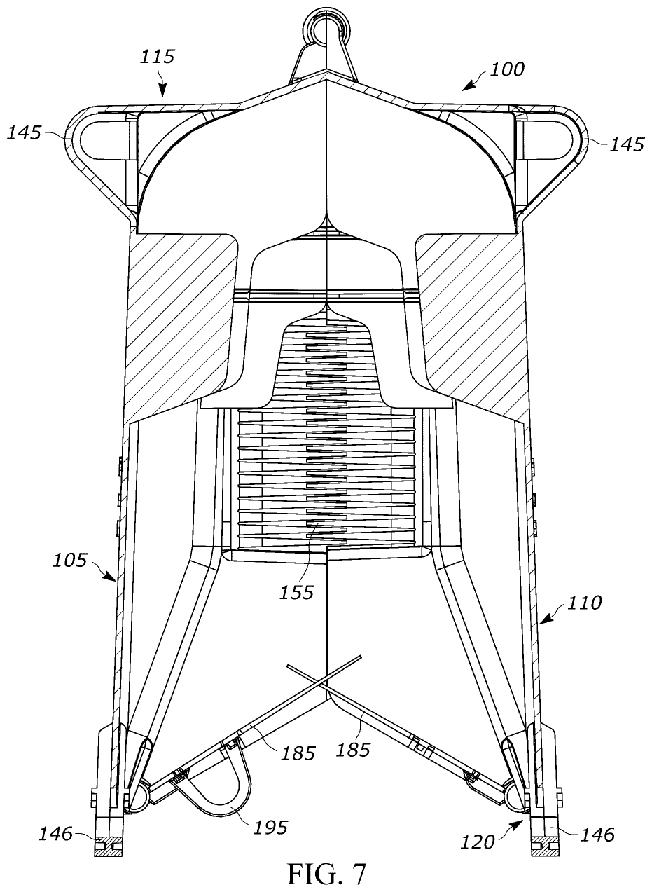

As shown in FIGS. 1 and 2, the clamp guard 100 may be formed form a first body or shell 105 and a second body or shell 110. The first and second shells 105, 110 may at least partially form an internal volume (see e.g., FIG. 7) that can house an electrical component. In some forms, the first and second bodies 105, 110 may be substantially similar in shape to one another. For example, so instances of the first body 105 may be substantially identical to the second body 110. This may assist in manufacturing where one part can be manufactured (e.g., molded) to form two elements.

The clamp guard 100 may include an upper end 115 and a lower end 120. The terms upper and lower may be used in relation to the orientation shown in FIG. 1 and may not restrict the orientation of the clamp guard 100 while in use.

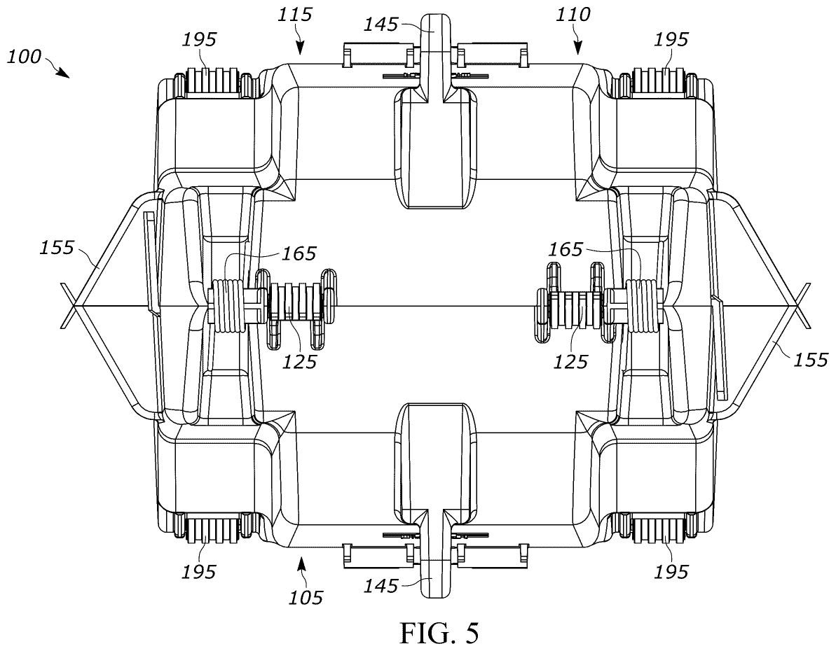

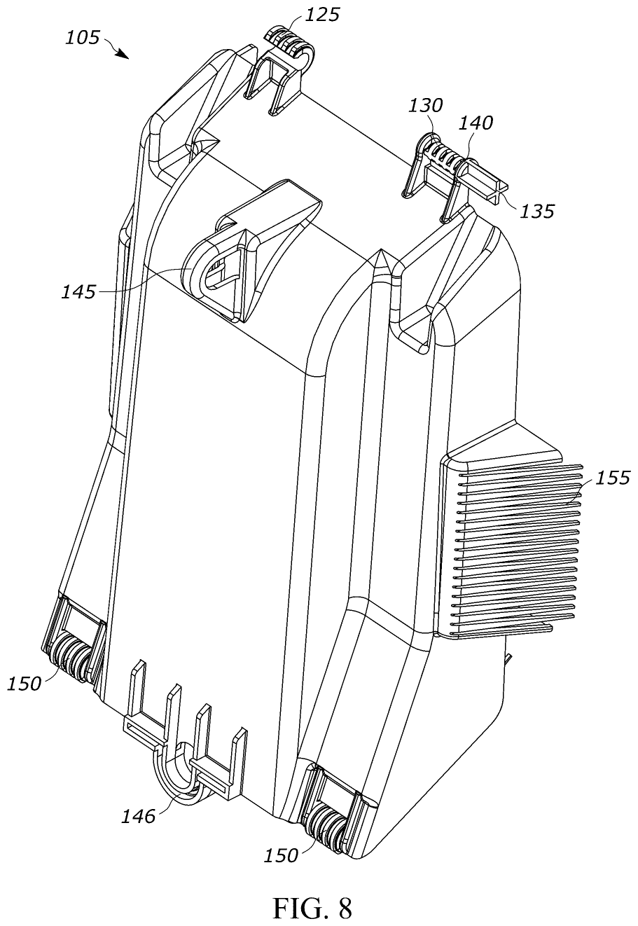

As shown in FIG. 8, the first body 105 may include a first connection feature 125 and a second connection feature 130 spaced apart from the first connection feature 125 proximate to the upper end 115. In the illustrated example, the first connection feature 125 and the second connection feature 130 have complementary shapes, although in other examples, the first and second connection features 125, 130 may be the same shape. For example, the first connection feature 125 may be a hook or C-shaped feature. The hook 125 may be oriented in a concave outwardly direction (e.g., away from the second body 110 as shown in FIG. 5). The second connection feature 130 may be an elongated body (e.g., a substantially cylindrical shape) with a complementary shape to the concave region of the first connection region 125.

The first and second connection features 125, 130 may engage the opposing connection feature (e.g., the second connection feature 130 and the first connection feature 125 respectively). As described in more detail below, engagement of the first and second connecting features 125, 130 may permit relative movement between the first and second bodies 105, 110.

With continued reference to FIG. 8, some forms of the second connection feature 130 may include a projection 135, which may extend away from the first connection feature 125 (e.g., it may extend toward an outer edge of the respective body 105, 110. The illustrated projection 135 may be formed with an X-shape, although any shape may be used (e.g., cylindrical, rectangular prismatic, etc.).

In certain forms, a lip 140 may partition the second connection feature 130 from the projection 135. This may assist in retaining the first connection feature 125 on the second connection feature 130 and limiting the first connection feature 125 from moving onto the projection 135.

The first and second bodies 105, 110 may also include at least one opening 145. Each illustrated body 105, 110 includes two openings 145, 146, one disposed proximate to the upper end 115 and one disposed at the lower end 120 (although any position may be used). On each respective body 105, 110, the illustrated openings 145, 146 may be aligned with one another in the vertical direction (although any orientation may be used).

In some forms, the upper opening 145 may project away from the respective body 105, 110 so that the direction of the opening 145 is oriented along the width of the body 105, 110 (e.g., in the direction between the first and second connection features 125, 130). The lower opening 146 may be oriented in a different direction (e.g., in a direction toward the other body 110, 105) than the upper opening 145.

Some forms of the bodies 105, 110 may include at least one connection rod 150 (e.g., two shown). The illustrated connection rods 150 may be spaced apart from one another proximate to a lower end of the respective body 105, 110. The lower opening 146 may be disposed between the two connection rods 150.

The illustrated connection rods 150 may be substantially rounded (e.g., cylindrical) and disposed between wall portions of the respective body 105, 110 (e.g., the connection rods 150 have no free ends). In other examples, one or more of the connection rods 150 may include a different shape (e.g., angled) and/or may include at least one free end.

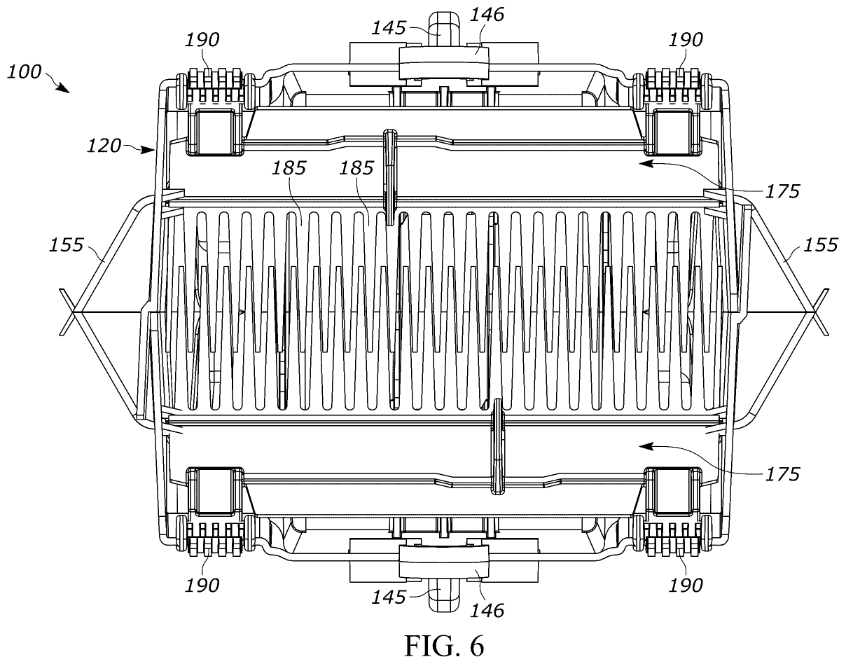

FIG. 8 also shows fingers 155 disposed along a side of the body 105 (or body 110). The illustrated example may include a plurality of fingers 155 on either side of the body 105, 110 (see e.g., FIGS. 5 and 6).

In the illustrated example, the plurality of fingers 155 on either side of the respective body 105,110 is formed as a plurality of cantilever members (e.g., with a fixed end and a free end). Each cantilever member 155 may be tapered so that a distance between adjacent free ends is greater than a distance between adjacent fixed ends.

In some forms, the fingers 155 may be constructed from a flexible material and/or may be sized to permit flexion. As described in more detail below, the fingers 155 may be able to bend and/or flex to permit ingress and/or egress from the clamp guard 100.

Returning to FIGS. 1 to 7, the first body 105 and the second body 110 may be coupled together. The bodies 105, 110 in the illustrated example may be removably coupled together, although in other examples, the first and second bodies 105, 110 may be permanently coupled together.

To couple the first and second bodies 105, 110 together, the first connection feature 125 on one body 105, 110 may be connected to the second connection feature 130 on the other body 110, 105. Additionally, the second connection feature 130 on one body 105, 110 may be connected to the first connection feature 125 on the other body 110, 105. In some forms, the first connection features 125 may connect to the respective second connection 130 features with a snap fit.

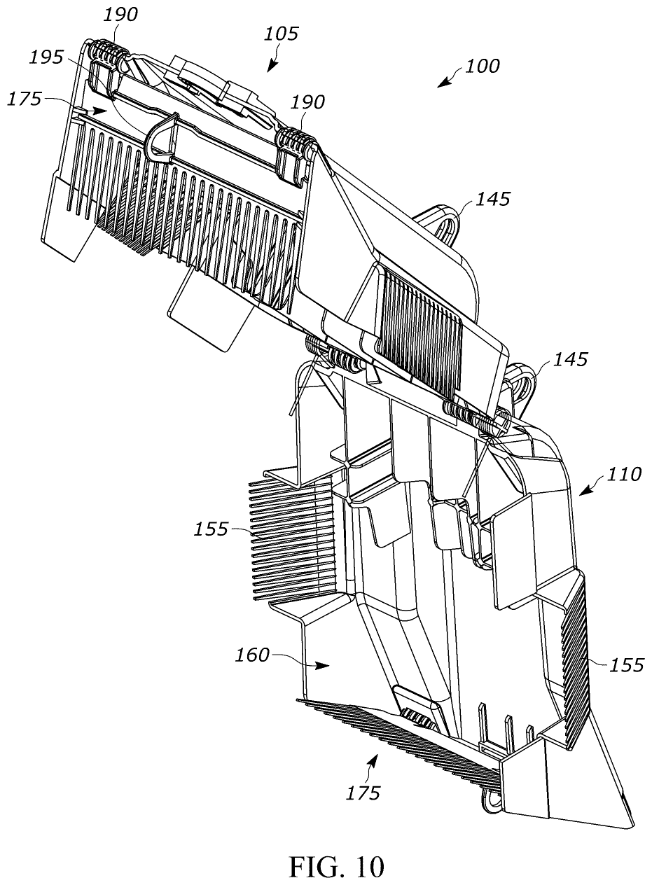

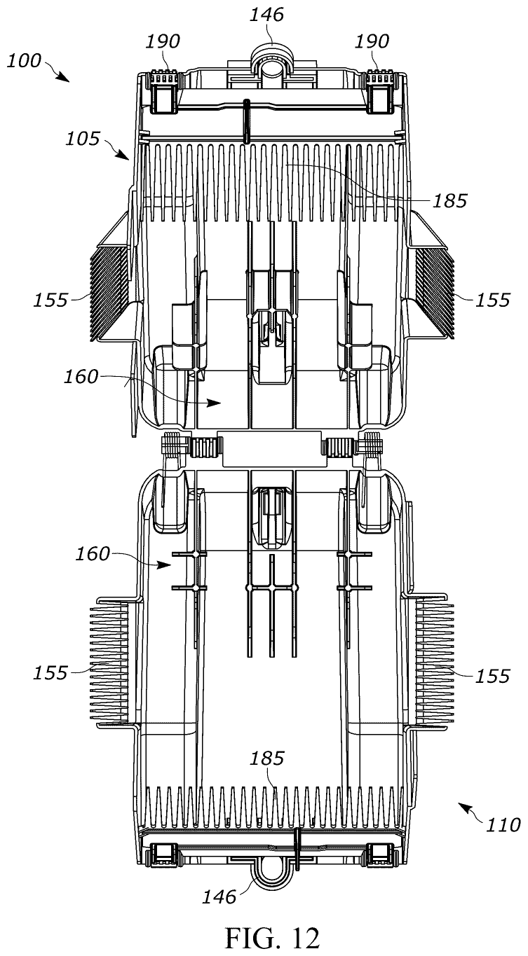

Once connected, the first body 105 and the second body 110 may be pivotable relative to one another. For example, FIGS. 1 to 7 may illustrate a closed position and FIGS. 10 to 12 may illustrate an open position. Each of the bodies 105, 110 may include a cavity 160. In the closed position, at least one edge of the first body 105 may be in contact with an edge of the second body 110 (see e.g., FIG. 7). The cavities 160 may be facing one another and at least partially enclosed within the clamp guard 100 thereby forming a clamp volume. In the open position, at least one of the bodies (e.g., the first body 105) pivots relative to the other body (e.g., the second body 110). In this open position, each cavity 160 may be at least partially exposed and there is no volume enclosed by the combination of the bodies 105, 110.

In the closed position, the plurality of fingers 155 on either side on one body (e.g., the first body 105) may interlace with the plurality of fingers 155 on the respective side of the other body 110 (e.g., the second body 110). The interlaced fingers 155 may provide a barrier that at least partially limits ingress or egress to the volume formed by the cavities 160.

In some forms, the fingers 155 are inclined away from the respective body 105, 110. The free ends of the fingers 155 may therefore be the widest portion of the respective body 105, 110. In other examples, the fingers 155 may be oriented toward a center of the respective body 105, 110. In that alternate example, the clamp volume may be smaller since the fingers 155 extend into the respective cavity 160.

Returning to FIG. 1, the bodies 105, 110 may be biased toward the closed position. For example, at least one biasing member 165 may be used to apply a bias to the first and second bodies 105, 110.

In some forms, the biasing member 165 is a torsion spring, although other forms of biasing members may be used. A torsion spring 165 may be coupled to one of the bodies 105, 110 about the projection 135. In the illustrated example, a torsion spring 165 is positioned on each projection 135, although in other examples, only one of the projections 165 may include a torsion spring.

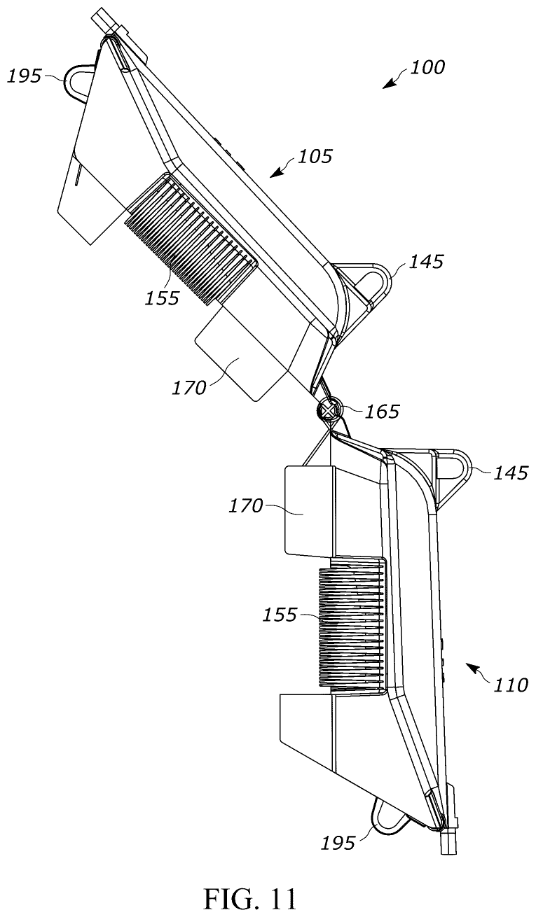

Each torsion spring 165 may wrap around the respective projection 135. The torsion spring 165 may include a pair of free ends which rest against one of the respective bodies 105, 110. As one body 105, 110 moves relative to the other body 110, 105, the spring 165 is compressed (e.g., because the body 105 contacts and moves the free end). In the open position of FIGS. 10 to 12, the first body 105 may be held in the open position against the spring bias (e.g., by a technician's hand) and the spring force is directed back toward the closed position (e.g., in the counterclockwise direction as viewed in FIG. 11). When the force counteracting the spring bias is released, the first body 105 may return toward the closed position.

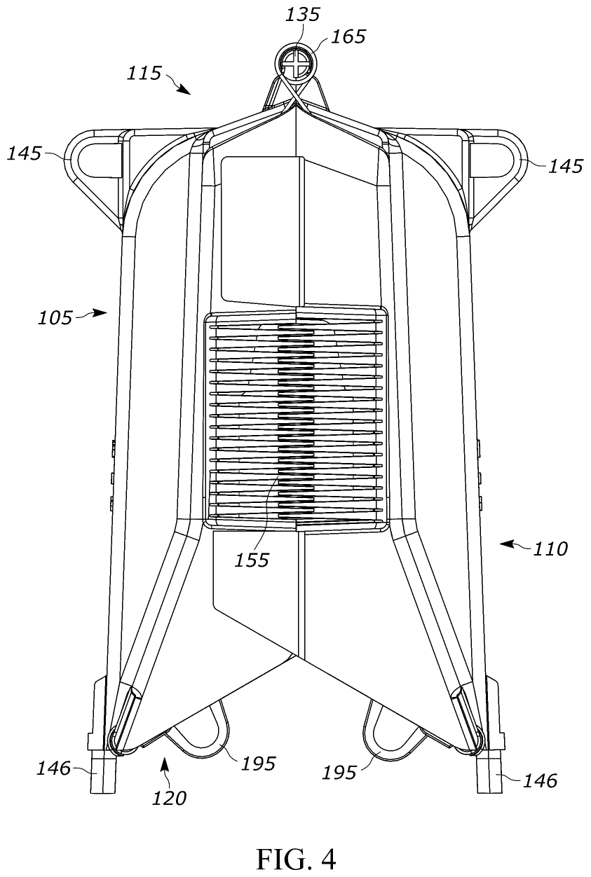

In some forms, the first body 105 and the second body 110 may include complementary latches 170 (see e.g., FIG. 4). For example, the latches 170 may engage and assist in maintaining the bodies 105, 110 in the closed position. In some forms, the bias from the springs 165 may be sufficient to engage the latches 170 as the first body 105 pivots toward the second body 110 and returns toward the closed position.

In the illustrated form, a lower end of each body 105, 110 (e.g., opposite to the first and second connection features 125, 130) may be open. For example, the lower end of each body 105, 110 may not include a surface. In the closed position, the volume formed by the cavities 160 may be open through the lower end of each body 105, 110.

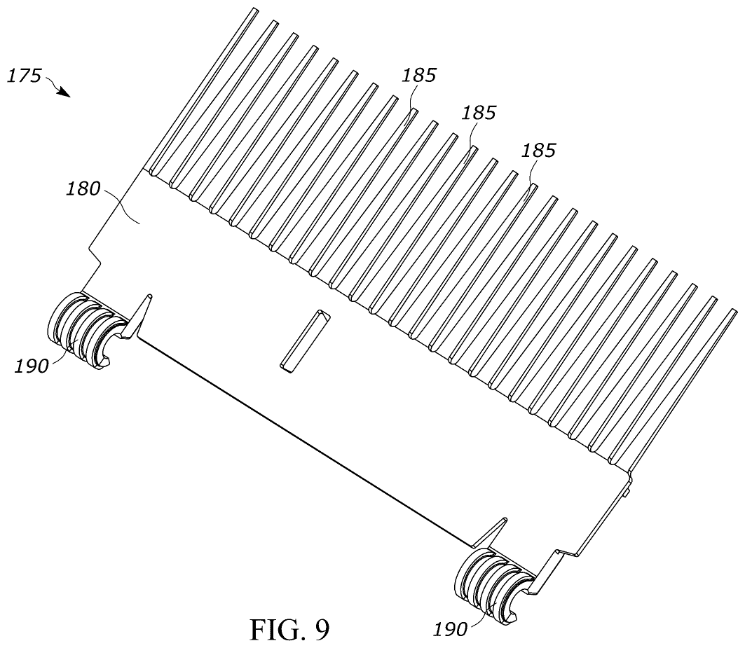

In some forms, a gate 175 may connect to each body 105, 110 proximate to the lower end and may at least partially close the lower end to further enclose the volume within the bodies 105, 110 in the closed position. As shown in FIG. 9, each gate 175 includes a body 180 with a plurality of fingers 185 extending away from the body 180. The illustrated body 180 may be a substantially planar member, although other examples may have different thicknesses or surface contours.

The plurality of fingers 185 on the gate 175 may be similar to the plurality of fingers 155 on the bodies 105, 110. For example, the plurality of fingers 185 may be formed as cantilever members with a fixed end connected to the body 180 and a free end extending away from the body 180. In some forms, each finger 185 may be tapered from the respective fixed end toward the free end. Although in other examples, the fingers 185 may not be tapered or they may be wider at the free end.

Each gate 175 may also include at least one connection feature 190 (e.g., two shown) that extends from the body 180 (e.g., in an opposite direction from the plurality of fingers 185). In the illustrated example, the connection features 190 of the gate 175 may be similar to the first connection feature 125. For example, the connection features 190 may be formed as a hook or C-shaped member.

In certain forms, the connection features 190 are each oriented in the same direction. For example, both connection features 190 have a concave section oriented into the page as shown in FIG. 9. However, in other examples, the connection features 190 may have different orientations (e.g., one concavity in a different direction than the other).

As shown in FIGS. 2 and 10, a gate 175 may be connected to each of the bodies 105, 110. Specifically, the connection features 190 of the respective gate 175 may connect to the connection rods 150. In the illustrated example, this may be a removable (e.g., snap-fit) connection, although the connection may be a permanent connection in other examples.

The gates 175 may be similar to the plurality of finger 155 on the side of the bodies 105, 110. For example, the fingers 185 of the gates 175 may intersect with one another to at least partially enclose the lower openings of the bodies 105, 110.

In some forms, the gates 175 may be oriented into the respective body 105, 110 (e.g., into the cavity) instead of being oriented outside of the respective body 105, 110 like the fingers 155. However, as explained below, the gates 175 may be movable relative to the respective body 105, 110 and could be oriented outside of the cavity.

In some forms, the connection features 190 may allow for pivoting movement about the connection rods 190. This pivoting movement may permit a technician to change the position of the gates 175. Specifically, this may permit access into the cavities 160 formed when the bodies 105, 110 are in the closed position.

In certain forms, each of the gates 175 may include a loop 195 (see e.g., FIG. 2). A tool (not show) may hook into the loop 195 and assist in adjusting the position of the respective gate 175. However, the gates 175 may also be manually moveable (e.g., without use of the tool).

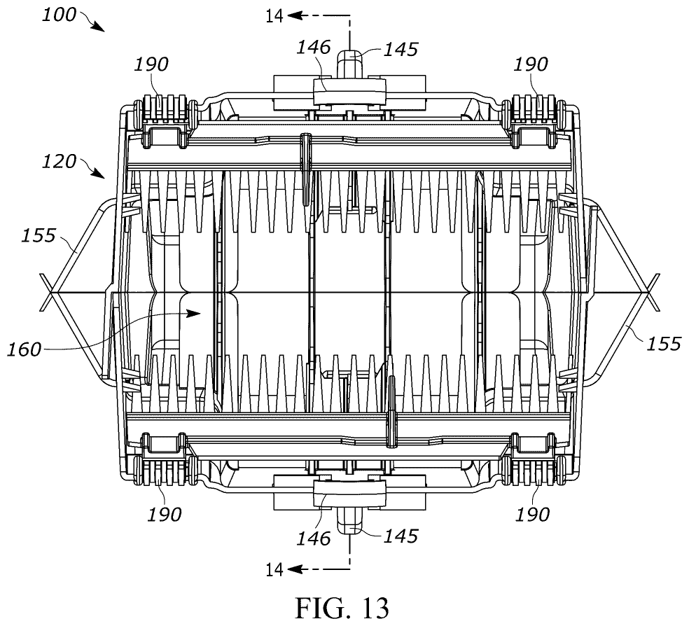

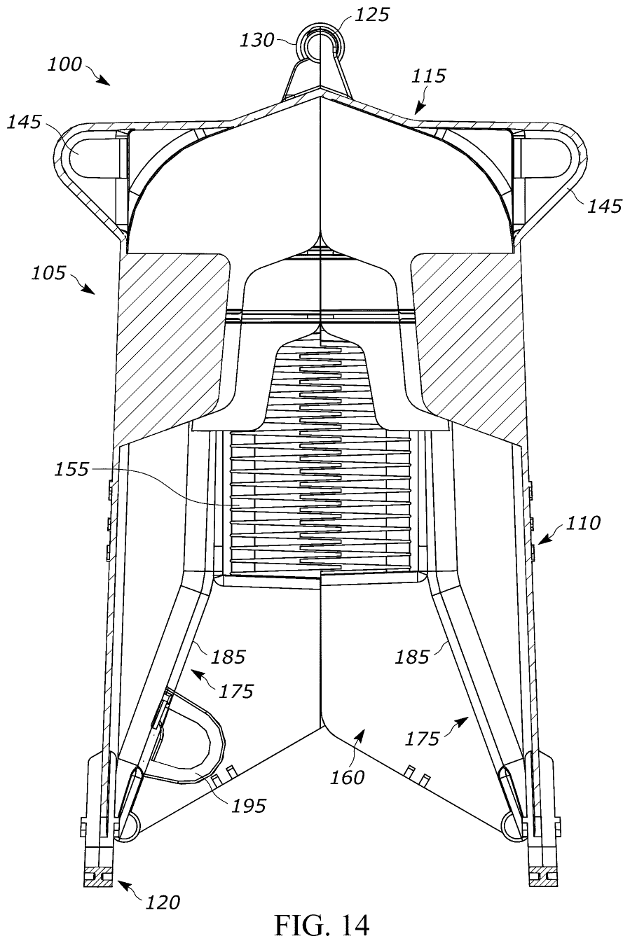

In some forms, the gates 175 may be moveable between a closed position (see e.g., FIG. 7) and an open position (see e.g., FIGS. 13 and 14). In the illustrated open position, the gates 175 are moved into the respective cavities 160, although in other examples, the gates 175 may be pulled out of the cavities 160. In either case, the fingers 185 on one gate 175 may not intersect with the fingers 185 on the other gate 175. This may provide substantially unobstructed access into the cavities 160 when the bodies 105, 110 are in the closed position.

In use, the guard 100 may be installed around an electrical component (e.g., connected to a conductor). The guard 100 may begin in the open position (see e.g., FIGS. 10 to 12). As described above, the first body 105 may pivot relative to the second body 110 against the bias of the torsion spring 165. A technician may use a tool (e.g., a hot stick-not shown) to pull the first body 105 by either of the openings 145, 146 relative to the second body 110.

While in this open position, the guard 100 may be positioned at least partially around a component. For example, the cavity 160 of the second body 110 may at least partially receive the component.

When the component is connected to a conductor (e.g., an overhead power line), the guard 100 may also be positioned so that the fingers 155 are positioned proximate to the conductor. For example, the second body 110 may be positioned so that the fingers 155 are proximate to (or in contact with) the conductor.

Once the second body 110 is properly positioned, the technician may release the first body 105 (e.g., by disconnecting the tool from the opening 145, 146). The torsion spring 165 may bias the first body 105 back toward the second body 110. In some forms, the bias in the torsion spring 165 may cause the first body 105 to latch to the second body 110. For example, the torque exerted by the torsion spring 165 may impart a sufficient velocity for the complementary latches to engage without further technician intervention. In other forms, the torsion spring 165 may return the first body 105 toward the closed position, and the technician may need to impart a force (e.g., by hand, using a tool, etc.) to cause the latches 170 to engage. In still other forms where the bodies 105, 110 do not include latches 170, the torsion spring 165 may simply return the first body 105 into contact with the second body 110.

As the first body 105 returns to the closed position (see e.g., FIGS. 1 and 2), the cavity 160 of the first body 105 may at least partially receive the component, and the volume formed by the cavities 160 may fully receive the component. The walls of the bodies 105, 110 may at least partially protect the component.

In some forms, the conductor connected to the component may also be received within the volume formed by the cavities 160. Unlike the component, the conductor may be larger than the guard 100 (e.g., it cannot be contained entirely within the volume). The conductor may be able to pass ingress and egress the cavities 160 via the plurality of fingers 155. As described above, the guard 100 may be aligned so that the plurality of fingers 155 are positioned proximate to the conductor. As the first body 105 pivots toward the closed position (e.g., in a clam shell movement), the fingers 155 on the first body 105 and the fingers 110 on the second body 110 may sandwich the conductor. Because the fingers 155 are flexible, contact with the conductor may move the fingers 155 away from the illustrated neutral position. The cantilevered fingers 155 may be biased to return toward the neutral position so that they remain in contact against the conductor.

In some forms, each finger 155 may be movable independent of the other fingers 155. For example, only fingers 155 in contact with the conductor may move away from the illustrated neutral position, while the remaining fingers 155 may remain in the neutral position. This may permit the fingers 155 to continue to substantially limit other elements from entering the cavities 160.

In some forms, a conductor (not shown) may be oriented substantially perpendicular to the conductor passing through the fingers 155. In other words, the guard 100 may at least partially surround a conductor that extends though the lower end of the guard 100. For example, the conductor may pass through the fingers 185 similar to how a conductor passes through the fingers 155 (e.g., moved away from a neutral position).

In the closed position, the guard 100 may act as a barrier to limit access to the component housed inside. For example, the solid bodies 105, 110 may limit climbing or flying wildlife (e.g., squirrels, birds, etc.) from reaching the component. The guard 100 may also limit some contaminants (e.g., animal waste) from reaching the component. In regions where the bodies 105, 110 are not completely solid (e.g., the sides proximate to the fingers 115 and the bottom proximate to the gates 175), the fingers 155, 185 biased to the interlaced neutral position may provide a barrier to wildlife ingress while still permitting the egress of one or more conductors.

As shown in FIGS. 13 and 14, the gates 175 may be moved (e.g., pivoted) while the bodies 105, 110 are in the closed position. In the illustrated example, the gates 175 may be pivoted into the respective cavity 160 so that the fingers 185 are not interlaced and an entrance into the cavities 160 through the lower end of the guard 100 is accessible.

In some forms, a technician may pivot one or more of the gates 175 while the guard 100 is enclosing the component. For example, the technician may move the gate 175 by hand or the technician may use a tool to move the gate 175 (e.g., via the exposed loop 195). When the gate(s) 175 are pivoted to the open position, the technician may access the component (and anything else within the volume) without having to move the guard 100 to the open position.

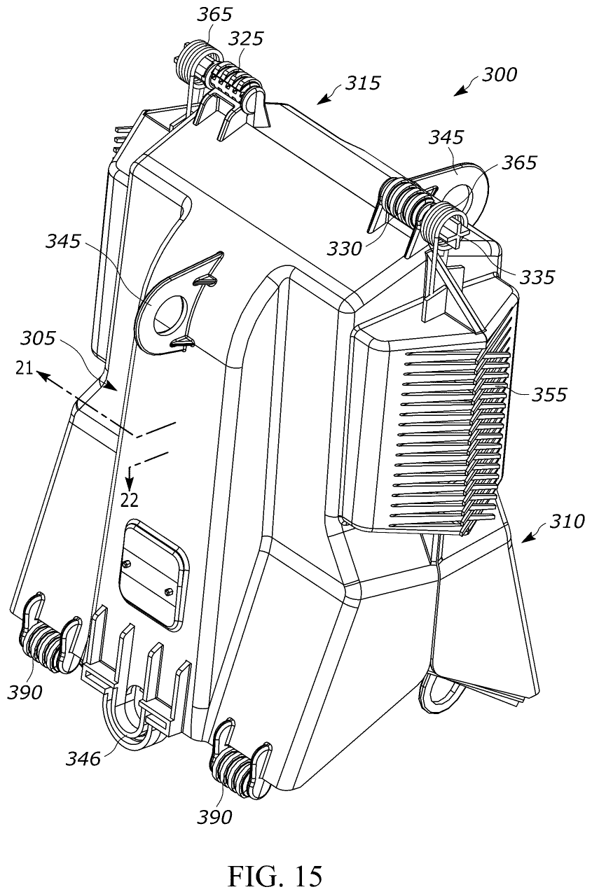

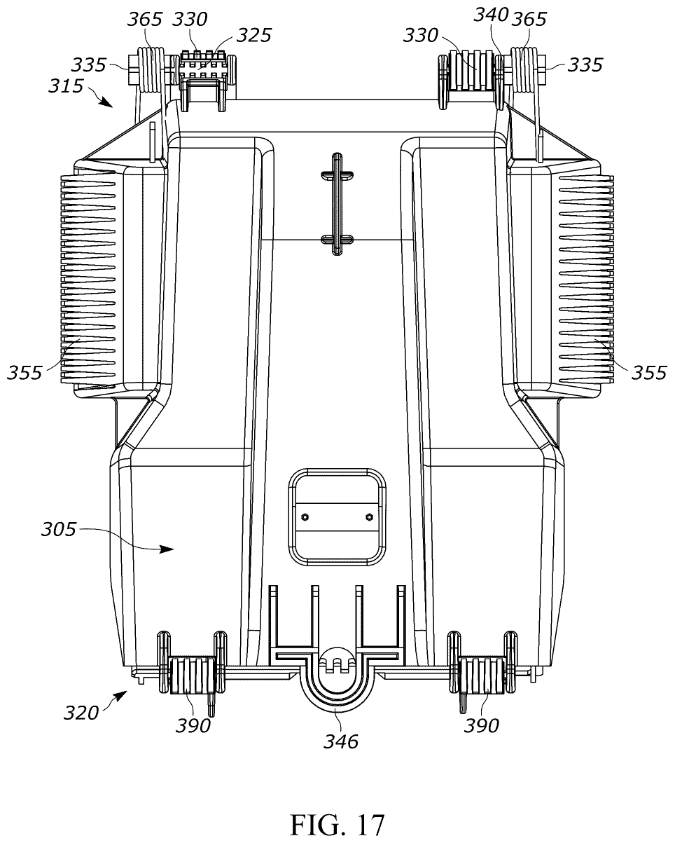

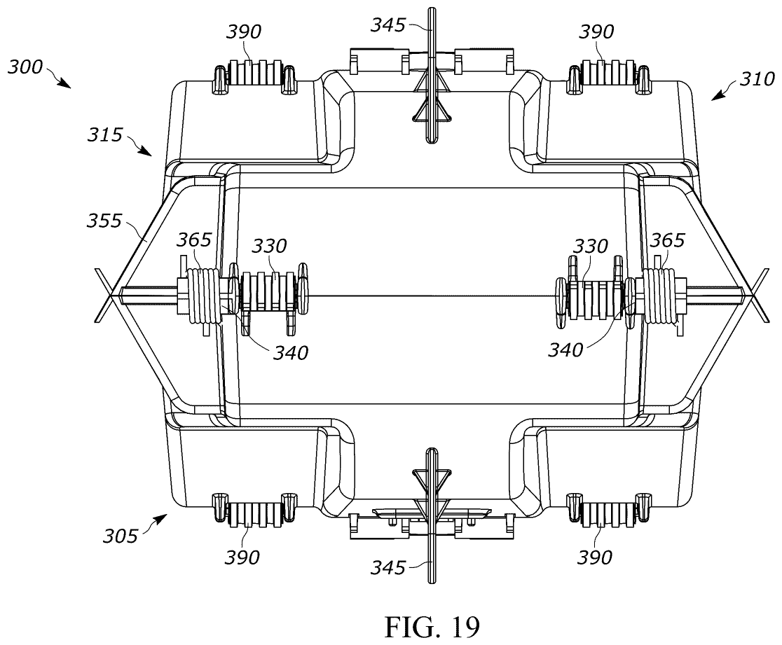

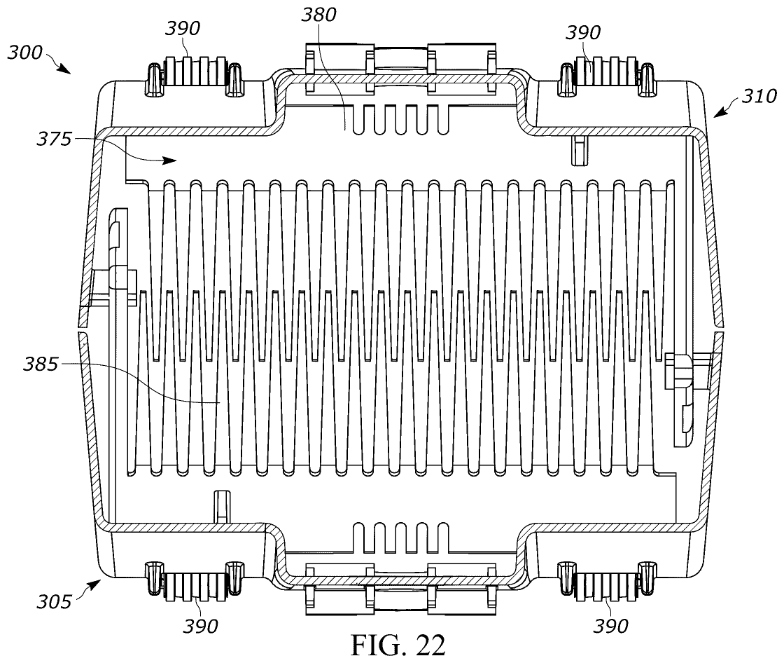

FIGS. 15 to 28 illustrate an alternate example of a guard 300 that is similar to guard 100. Similar elements are labeled with the same reference number plus “200”. Only some similarities and differences between the guard 100 and the guard 300 are described below.

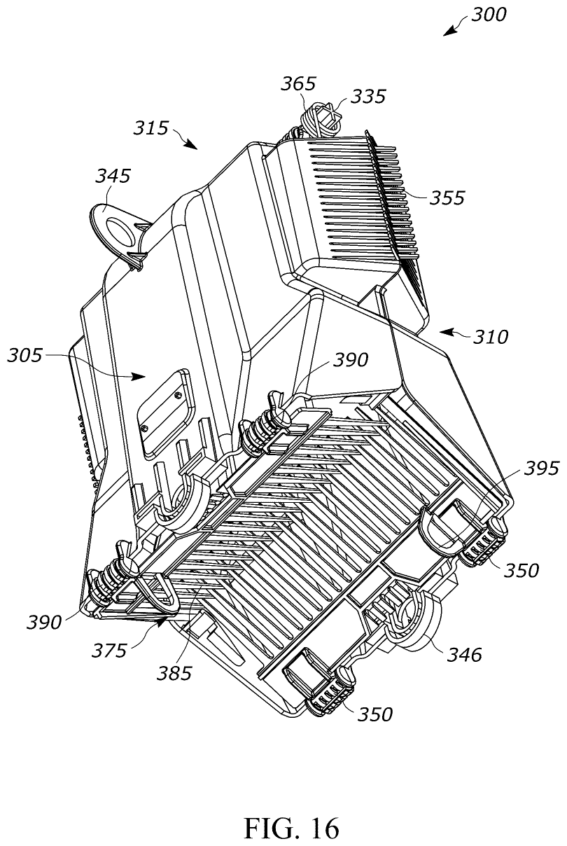

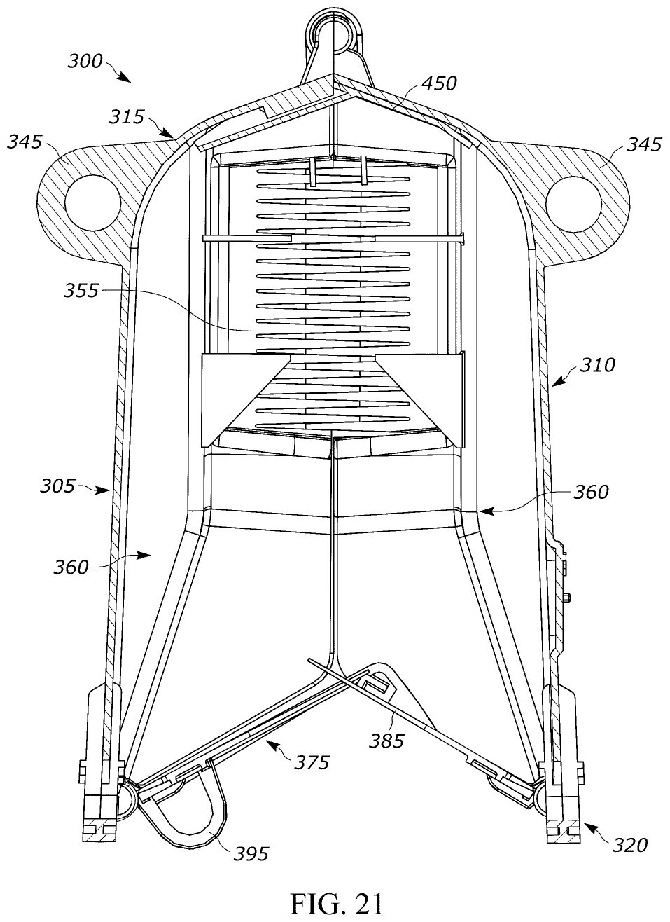

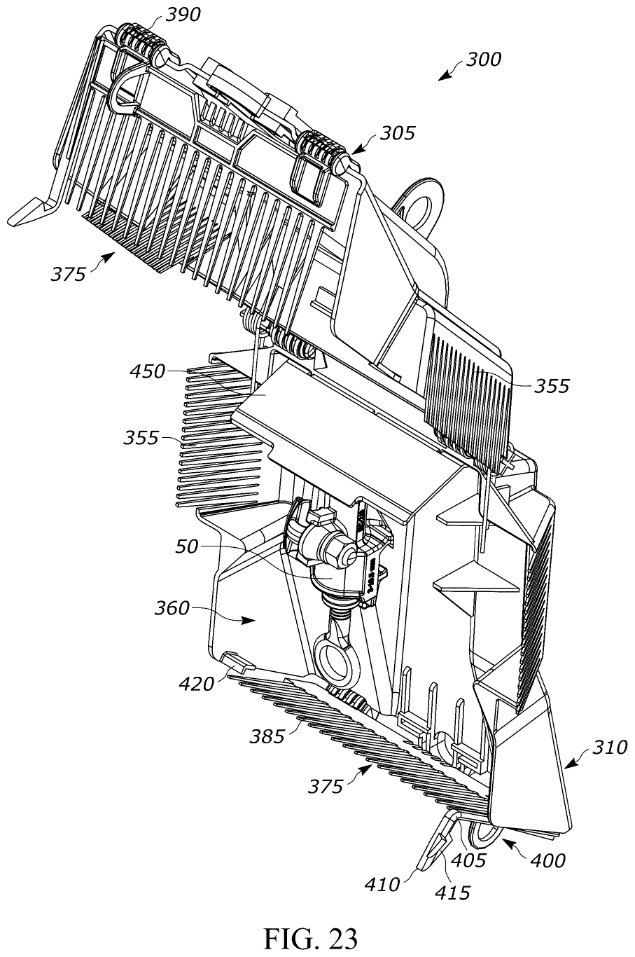

As shown in FIGS. 15 and 16, the clamp guard 300 may be formed form a first body or shell 305 and a second body or shell 310. The first and second shells 305, 310 may at least partially form an internal volume (see e.g., FIG. 21) that can house an electrical component 50 (see e.g., FIG. 23). In some forms, the first and second bodies 305, 310 may be substantially similar in shape to one another. For example, so instances of the first body 305 may be substantially identical to the second body 310. This may assist in manufacturing where one part can be manufactured (e.g., molded) to form two elements.

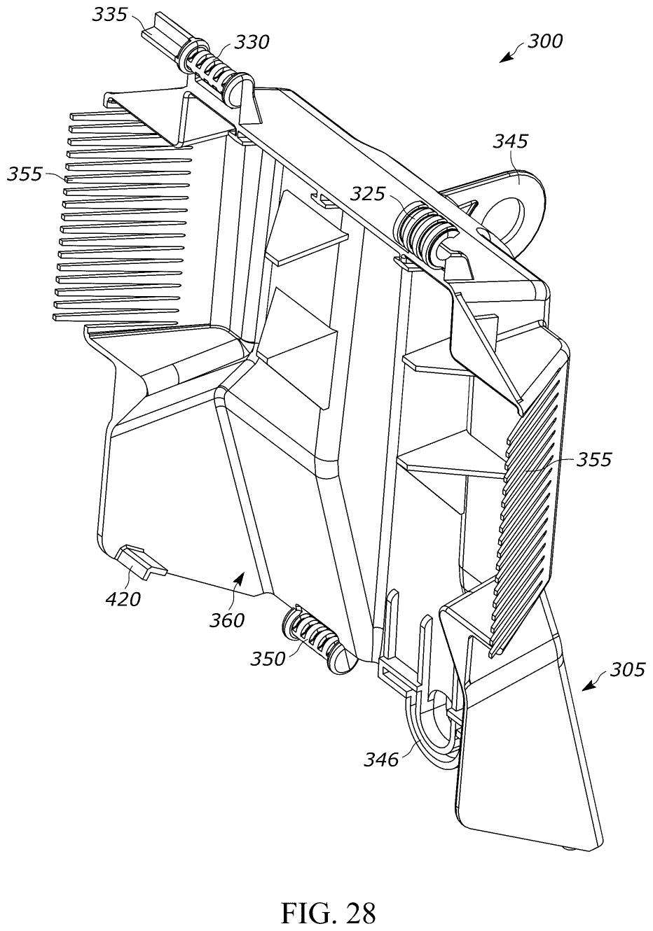

As shown in FIG. 28, the first body 305 may include a first connection feature 325 and a second connection feature 330 spaced apart from the first connection feature 325 proximate to the upper end 315. The first and second connection features 325, 330 may be substantially the same as the first and second connection features 125, 130, although in other examples the connection features 325, 330 may be different (e.g., both the same shape or any other shape). The projection 335, which may extend away from the first connection feature 325 and may be similarly shaped to the projection 135. A lip 340 may partition the second connection feature 330 from the projection 335. This may assist in retaining the first connection feature 325 on the second connection feature 330 and limiting the first connection feature 325 from moving onto the projection 335.

The first and second bodies 305, 310 may each include two openings 345, 346, which may be oriented in substantially the same position as the openings 145, 146. For example, the upper opening 345 may project away from the respective body 305, 310 and the lower opening 346 may be oriented in a different direction (e.g., in a direction toward the other body 310, 305) than the upper opening 345. However, in other examples, one or more of the openings 345, 346 may include a different orientation.

Some forms of the bodies 305, 310 may include at least one connection rod 350 (e.g., two shown). The illustrated connection rods 350 may be spaced apart from one another proximate to a lower end of the respective body 305, 310. The lower opening 346 may be disposed between the two connection rods 350. Similar to the connection rods 150, the connection rods 350 may be substantially rounded (e.g., cylindrical) and disposed between wall portions of the respective body 305, 310 (e.g., the connection rods 350 have no free ends). In other examples, one or more of the connection rods 350 may include a different shape (e.g., angled) and/or may include at least one free end.

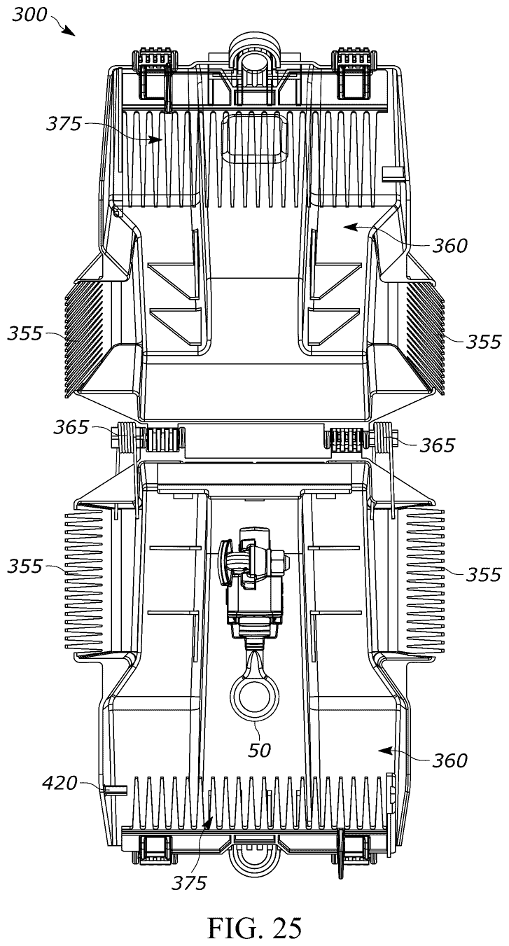

FIG. 28 also shows fingers 355 disposed along a side of the body 305 (or body 310). The illustrated example may include a plurality of fingers 355 on either side of the body 305, 310 (see e.g., FIG. 25).

In some forms, the fingers 355 may be formed as a plurality of cantilever members (e.g., with a fixed end and a free end) and/or may be constructed from a flexible material and/or may be sized to permit flexion. Some forms of the fingers 355 may tapered so that a distance between adjacent free ends is greater than a distance between adjacent fixed ends. This tapering may assist in permitting the fingers 355 on the different bodies 305, 310 to interlace with one another.

The first and second bodies 305, 310 may be coupled together (e.g., removably coupled or permanently coupled). To couple the first and second bodies 305, 310 together, the first connection feature 325 on one body 305, 310 may be connected to the second connection feature 330 on the other body 310, 305. Additionally, the second connection feature 330 on one body 305, 310 may be connected to the first connection feature 325 on the other body 310, 305. In some forms, the first connection features 325 may connect to the respective second connection 330 features with a snap fit.

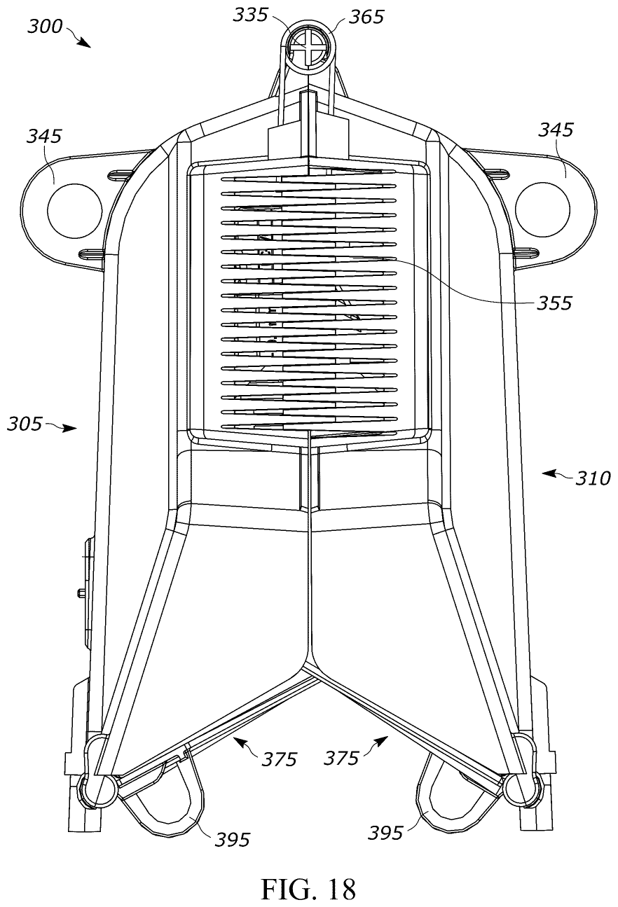

Once connected, the first body 305 and the second body 310 may be pivotable relative to one another. For example, FIGS. 15 to 22 may illustrate a closed position and FIGS. 23 to 25 may illustrate an open position. Each of the bodies 305, 310 may include a cavity 360. In the closed position, at least one edge of the first body 305 may be in contact with an edge of the second body 310 (see e.g., FIG. 18). The cavities 360 may be facing one another and at least partially enclosed within the clamp guard 300 thereby forming a clamp volume. In the open position, at least one of the bodies (e.g., the first body 305) pivots relative to the other body (e.g., the second body 310). In this open position, each cavity 360 may be at least partially exposed and there is no volume enclosed by the combination of the bodies 305, 310.

In the closed position, the plurality of fingers 355 on either side on one body (e.g., the first body 305) may interlace with the plurality of fingers 355 on the respective side of the other body (e.g., the second body 310). The interlaced fingers 355 may provide a barrier that at least partially limits ingress or egress to the volume formed by the cavities 360.

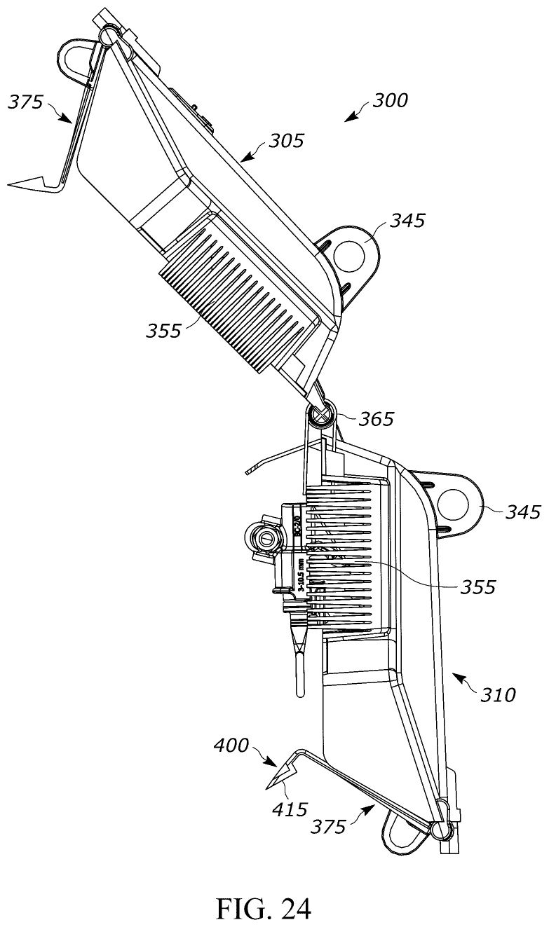

Returning to FIG. 15, the bodies 305, 310 may be biased toward the closed position. For example, at least one biasing member 365 (e.g., a torsion spring) may be used to apply a bias to the first and second bodies 305, 310. As one body 305, 310 moves relative to the other body 310, 305, the spring 365 is compressed (e.g., because the body 305 contacts and moves the free end). In the open position of FIGS. 23 to 25, the first body 305 may be held in the open position against the spring bias (e.g., by a technician's hand) and the spring force is directed back toward the closed position (e.g., in the counterclockwise direction as viewed in FIG. 24). When the force counteracting the spring bias is released, the first body 305 may return toward the closed position.

In some forms, a gate 375 may connect to each body 305, 310 proximate to the lower end and may at least partially close the lower end to further enclose the volume within the bodies 305, 310 in the closed position. Each gate 375 may include a body 380 with a plurality of fingers 385 extending away from the body 380. The illustrated body 380 may be a substantially planar member, although other examples may have different thicknesses or surface contours. The plurality of fingers 385 may be formed as cantilever members with a fixed end connected to the body 380 and a free end extending away from the body 380. In some forms, each finger 385 may be tapered from the respective fixed end toward the free end (e.g., to permit interlacing of the fingers 385), although the fingers 385 may be any shape.

Each gate 375 may also include at least one connection feature 390 (e.g., two shown) that extends from the body 380 (e.g., in an opposite direction from the plurality of fingers 385). The connection features 390 may be formed as a hook or C-shaped member. The connection features 390 of the respective gate 375 may connect to the connection rods 350. In the illustrated example, this may be a removable (e.g., snap-fit) connection, although the connection may be a permanent connection in other examples.

The connection features 390 may allow for pivoting movement about the connection rods 390. This pivoting movement may permit a technician to change the position of the gates 375. Specifically, this may permit access into the cavities 160 formed when the bodies 305, 310 are in the closed position.

In certain forms, each of the gates 375 may include a loop 395 (see e.g., FIG. 18). A tool (not show) may hook into the loop 395 and assist in adjusting the position of the respective gate 375. However, the gates 375 may also be manually moveable (e.g., without use of the tool).

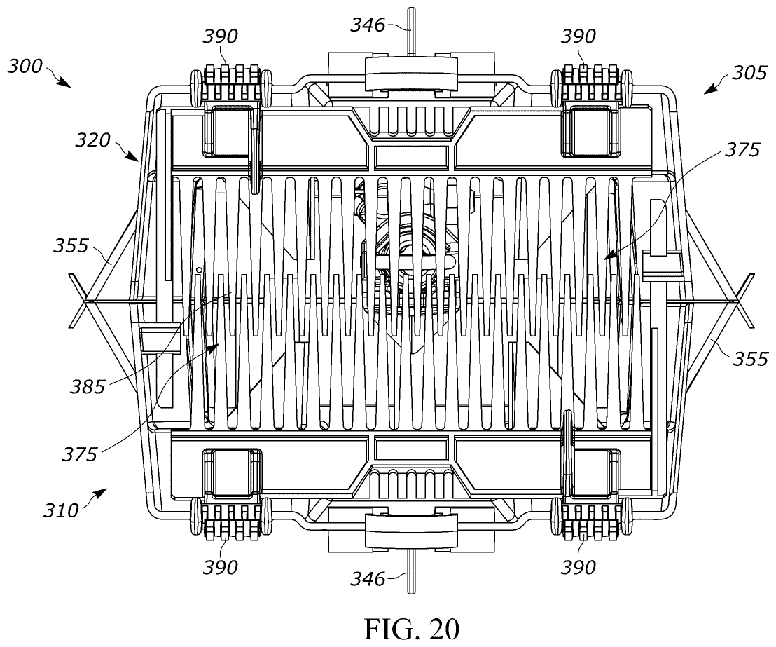

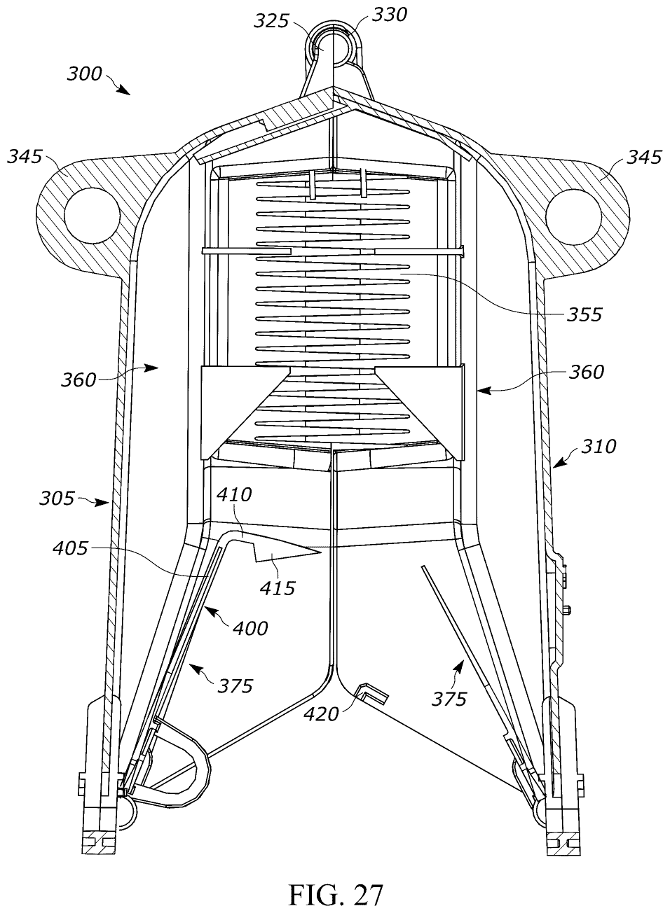

In some forms, the gates 375 may be moveable between a closed position (see e.g., FIG. 20) and an open position (see e.g., FIG. 27). In the illustrated open position, the gates 375 are moved into the respective cavities 360, although in other examples, the gates 375 may be pulled out of the cavities 360. In either case, the fingers 385 on one gate 375 may not intersect with the fingers 385 on the other gate 375. This may provide substantially unobstructed access into the cavities 360 when the bodies 305, 310 are in the closed position.

In some forms, each gate 375 may include a latch 400. The latch 400 may be formed at an end of the gate 375 (e.g., spaced apart from the fingers 385). In the illustrated example, the latch 400 may include a hook shape with a first portion 405 and a second portion 410 inclined relative to the first portion 405 (e.g., inclined between about 45° and about 100°). The latch 400 may include an undercut 415 along the second portion 410.

In some forms, a complementary latch 420 may be included within the cavities 360. In the illustrated complementary latch 420 is coupled to an internal surface of the respective body 305, 310. However, in other examples, the complementary latch 420 may be included on an opposite side of the gate 375 from the latch 400.

In use, the guard 300 may be installed around an electrical component 50 (e.g., connected to a conductor). The guard 300 may begin in the open position (see e.g., FIGS. 23 to 25). As described above, the first body 305 may pivot relative to the second body 310 against the bias of the torsion spring 365. A technician may use a tool (e.g., a hot stick-not shown) to pull the first body 305 by either of the openings 345, 346 relative to the second body 310.

While in this open position, the guard 300 may be positioned at least partially around a component 50. For example, the cavity 360 of the second body 310 may at least partially receive the component 50 (see e.g., FIG. 23).

Once the second body 310 is properly positioned, the technician may release the first body 305 (e.g., by disconnecting the tool from the opening 345, 346). The torsion spring 365 may bias the first body 305 back toward the second body 310. In some forms, the bias in the torsion spring 365 may cause the first body 305 to return to the second body 310. As the first body 305 returns to the closed position (see e.g., FIGS. 15 and 21), the cavity 360 of the first body 305 may at least partially receive the component 50, and the volume formed by the cavities 360 may fully receive the component. The walls of the bodies 305, 310 may at least partially protect the component 50.

In some forms, the latch 400 and complementary latch 420 may engage with one another. For example, the latch 400 on one gate 375 may engage the complementary latch 420 in the other body 305, 310. Specifically, the undercut 415 may engage the complementary latch 420 (e.g., with a snap fit). When engaged, the gates 375 may be unable to move relative to one another. Additionally, the bodies 305, 310 may be unable to move relative to one another. Thus, the engagement between the latch 400 and the complementary latch 420 may secure the bodies in the closed position.

A technician may be able to decouple the latch 400 from the complementary latch 420 by moving the latch 400 relative to the complementary latch 420. For example, the technician (e.g., by hand or using a tool) may be able to move an end of the latch 400 to decouple the latch 400 (e.g., so that the undercut 415 is decoupled from the complementary latch 420). Once this occurs, the gates 375 and the bodies 305, 310 may be movable relative to one another respectively.

In some forms, the conductor connected to the component 50 may also be received within the volume formed by the cavities 360. Unlike the component 50, the conductor may be larger than the guard 300 (e.g., it cannot be contained entirely within the volume). The conductor may be able to pass ingress and egress the cavities 360 via the plurality of fingers 355.

In some forms, each finger 355 may be movable independent of the other fingers 355. For example, only fingers 355 in contact with the conductor may move away from the illustrated neutral position, while the remaining fingers 355 may remain in the neutral position. This may permit the fingers 355 to continue to substantially limit other elements from entering the cavities 360.

In the closed position, the guard 300 may act as a barrier to limit access to the component housed inside. For example, the solid bodies 305, 310 may limit climbing or flying wildlife (e.g., squirrels, birds, etc.) from reaching the component. The guard 300 may also limit some contaminants (e.g., animal waste) from reaching the component. In regions where the bodies 305, 310 are not completely solid (e.g., the sides proximate to the fingers 315 and the bottom proximate to the gates 375), the fingers 355, 385 biased to the interlaced neutral position may provide a barrier to wildlife ingress while still permitting the egress of one or more conductors.

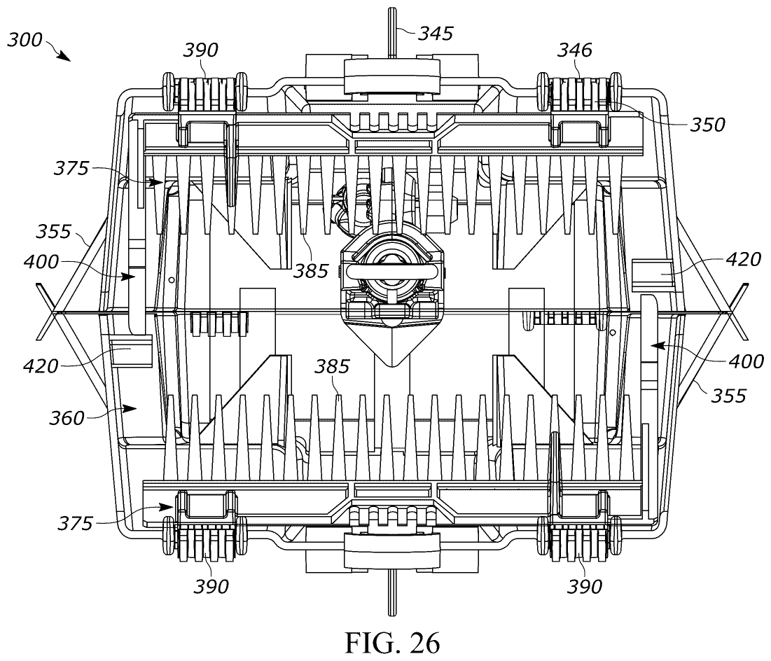

As shown in FIGS. 26 and 27, once the latch 400 is released, the gates 375 may be moved (e.g., pivoted) while the bodies 305, 310 are in the closed position. In the illustrated example, the gates 375 may be pivoted into the respective cavity 360 so that the fingers 385 are not interlaced and an entrance into the cavities 360 through the lower end of the guard 300 is accessible.

In some forms, a technician may pivot one or more of the gates 375 while the guard 300 is enclosing the component. For example, the technician may move the gate 375 by hand or the technician may use a tool to move the gate 375 (e.g., via the exposed loop 395). When the gate(s) 375 are pivoted to the open position, the technician may access the component (and anything else within the volume) without having to move the guard 300 to the open position.

In some forms, the guard 300 may include a shield 450. As illustrated in FIG. 21, the shield 450 may be disposed within the cavities 360 proximate to the upper end 315 of the guard 300. The shield 450 may be positioned proximate to a seam between the first and second bodies 305, 310. The illustrated shield 450 is connected to the second body 310, although in other examples, the shield may be connected to the first body 305. Because the shield 350 may be attached to only one body 305, 310, it may not limit movement of the bodies 305, 310 between the open and closed positions.

In use, the shield 450 may limit the ingress of fluids into the cavities 360. For example, the shield 450 may limit precipitation and/or bird droppings from entering the cavities 360 and damaging the component 50. Some forms of the shield 450 may form a seal in the closed position although other forms may simply form a barrier.

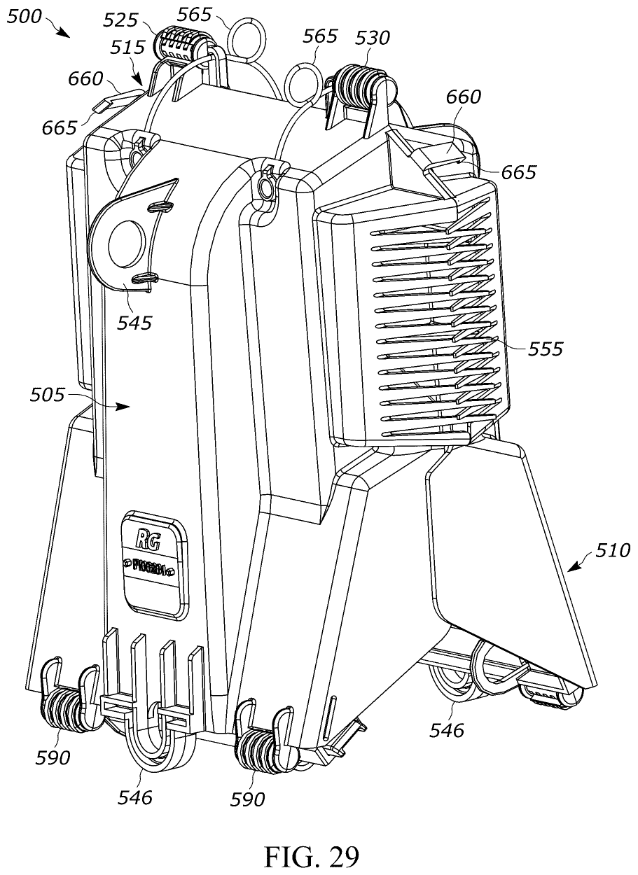

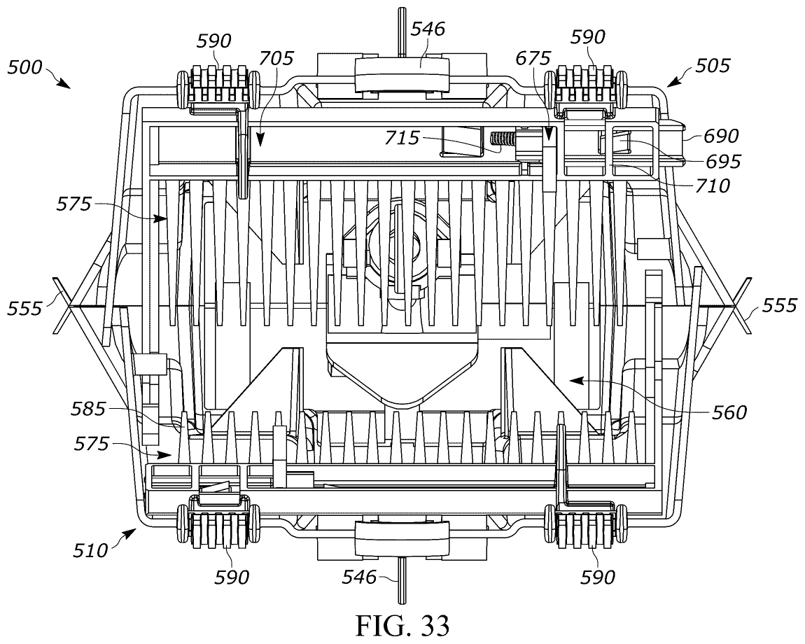

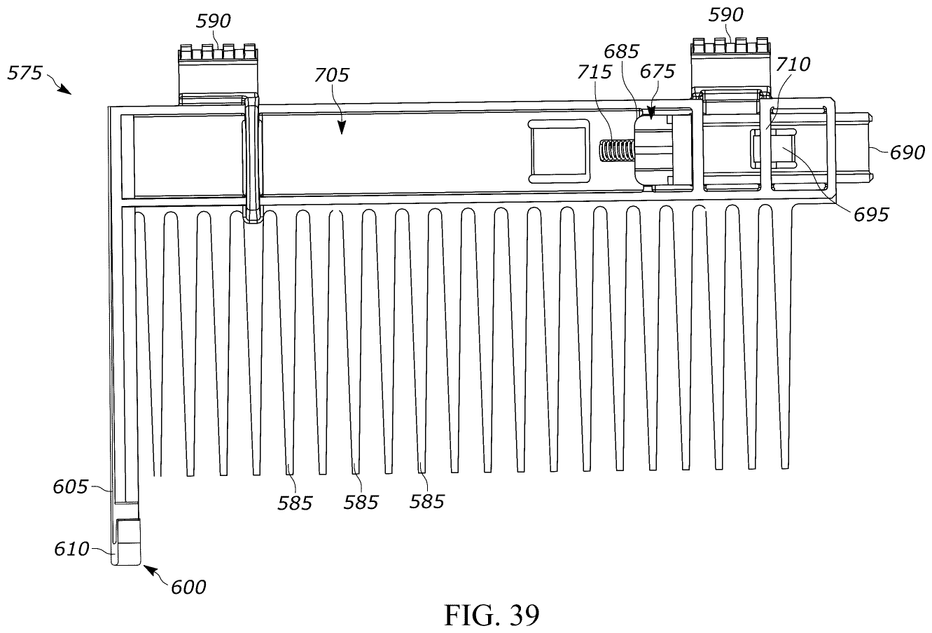

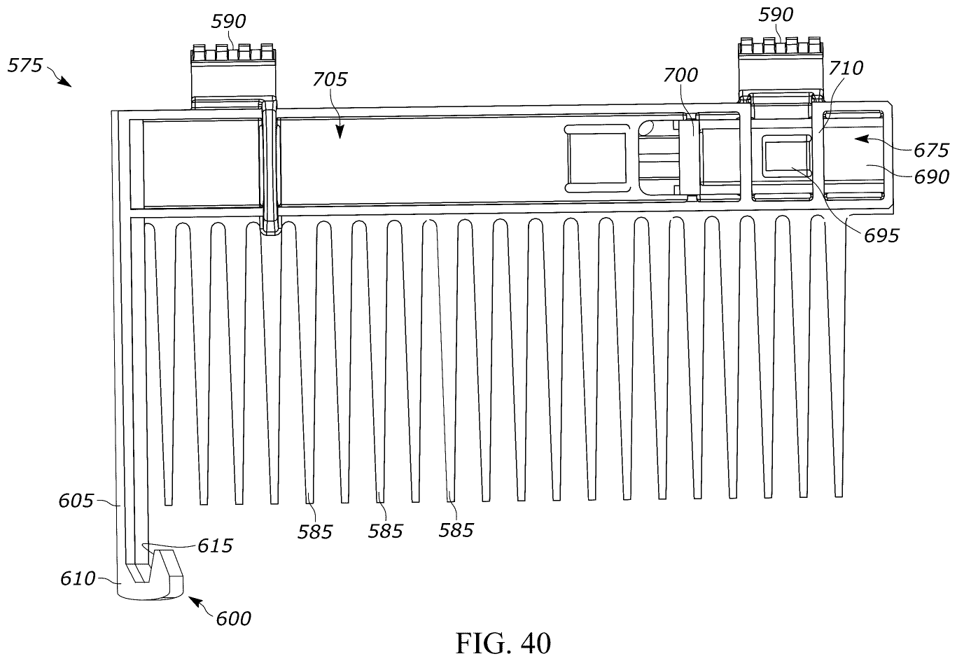

FIGS. 29 to 42 illustrate an alternate example of a guard 500 that is similar to guard 100. Similar elements are labeled with the same reference number plus “400”. Only some similarities and differences between the guard 100 and the guard 400 are described below.

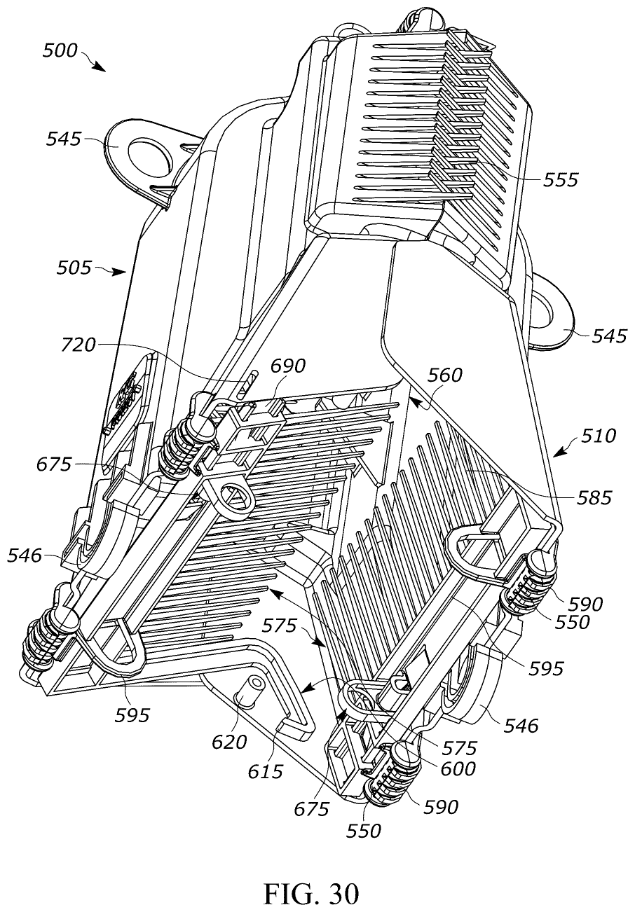

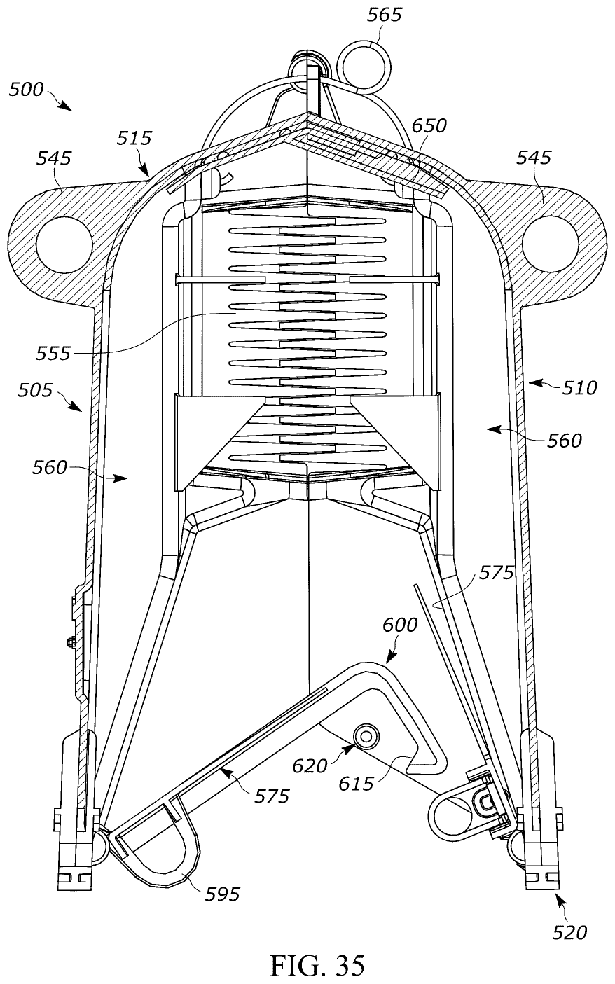

As shown in FIGS. 29 and 30, the clamp guard 500 may be formed form a first body or shell 505 and a second body or shell 510. The first and second shells 505, 510 may at least partially form an internal volume (see e.g., FIG. 35) that can house an electrical component. In some forms, the first and second bodies 505, 510 may be substantially similar in shape to one another. For example, so instances of the first body 505 may be substantially identical to the second body 510. This may assist in manufacturing where one part can be manufactured (e.g., molded) to form two elements.

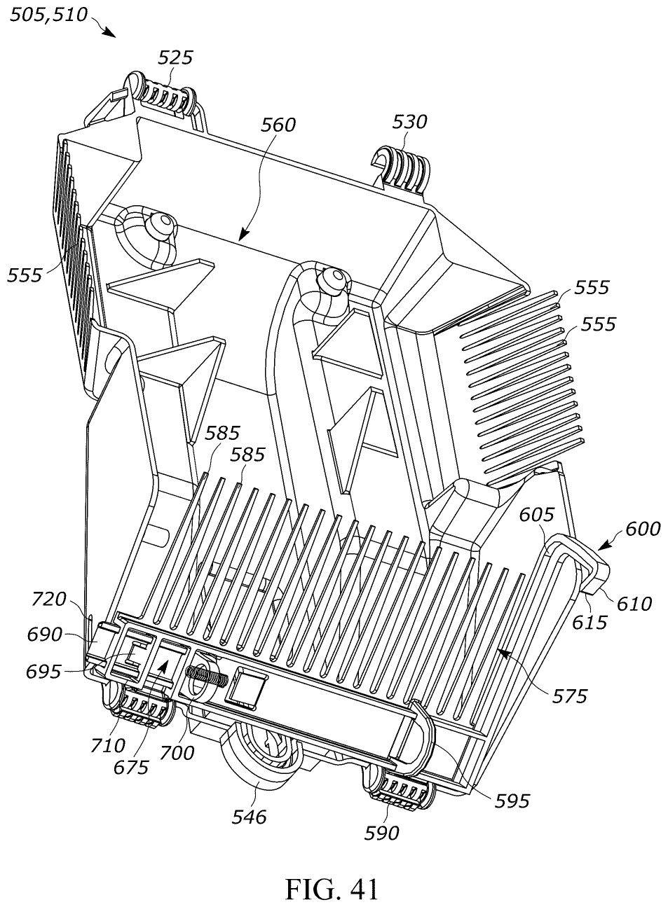

As shown in FIG. 41, the first body 505 may include a first connection feature 525 and a second connection feature 530 spaced apart from the first connection feature 525 proximate to the upper end 515. The first and second connection features 525, 530 may be substantially the same as the first and second connection features 125, 130, although in other examples the connection features 525, 530 may be different (e.g., both the same shape or any other shape).

The first and second bodies 505, 510 may each include two openings 545, 546, which may be oriented in substantially the same position as the openings 145, 146. For example, the upper opening 545 may project away from the respective body 505, 510 and the lower opening 546 may be oriented in a different direction (e.g., in a direction toward the other body 510, 505) than the upper opening 545. However, in other examples, one or more of the openings 545, 546 may include a different orientation.

Some forms of the bodies 505, 510 may include at least one connection rod 550 (e.g., two shown). The illustrated connection rods 550 may be spaced apart from one another proximate to a lower end of the respective body 505, 510. The lower opening 546 may be disposed between the two connection rods 550. Similar to the connection rods 150, the connection rods 550 may be substantially rounded (e.g., cylindrical) and disposed between wall portions of the respective body 505, 510 (e.g., the connection rods 550 have no free ends). In other examples, one or more of the connection rods 550 may include a different shape (e.g., angled) and/or may include at least one free end.

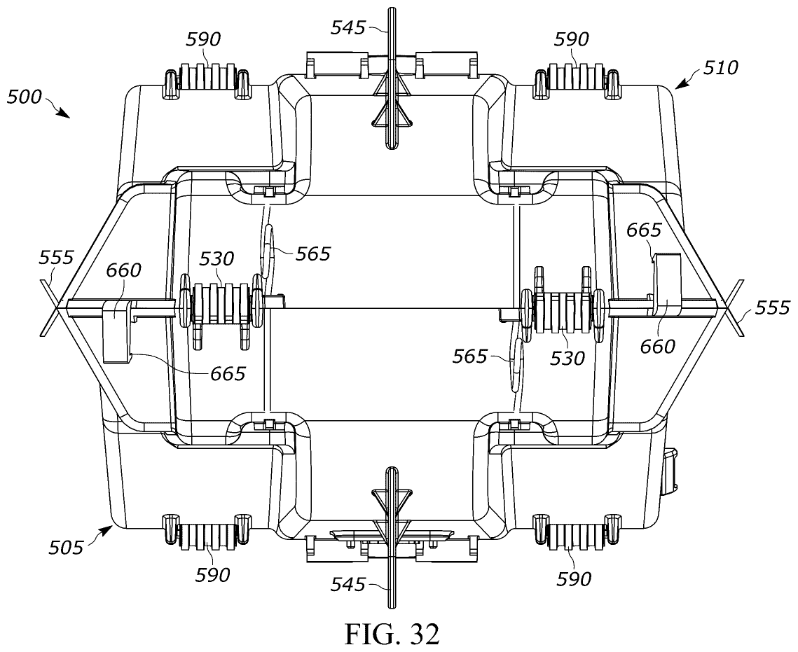

FIG. 29 also shows fingers 555 disposed along a side of the body 505 (or body 510). The illustrated example may include a plurality of fingers 555 on either side of the body 505, 510 (see e.g., FIG. 32).

In some forms, the fingers 555 may be formed as a plurality of cantilever members (e.g., with a fixed end and a free end) and/or may be constructed from a flexible material and/or may be sized to permit flexion. Some forms of the fingers 555 may tapered so that a distance between adjacent free ends is greater than a distance between adjacent fixed ends. This tapering may assist in permitting the fingers 555 on the different bodies 505, 510 to interlace with one another.

The first and second bodies 505, 510 may be coupled together (e.g., removably coupled or permanently coupled). To couple the first and second bodies 505, 510 together, the first connection feature 525 on one body 505, 510 may be connected to the second connection feature 350 on the other body 510, 505. Additionally, the second connection feature 530 on one body 505, 510 may be connected to the first connection feature 525 on the other body 510, 505. In some forms, the first connection features 525 may connect to the respective second connection 530 features with a snap fit.

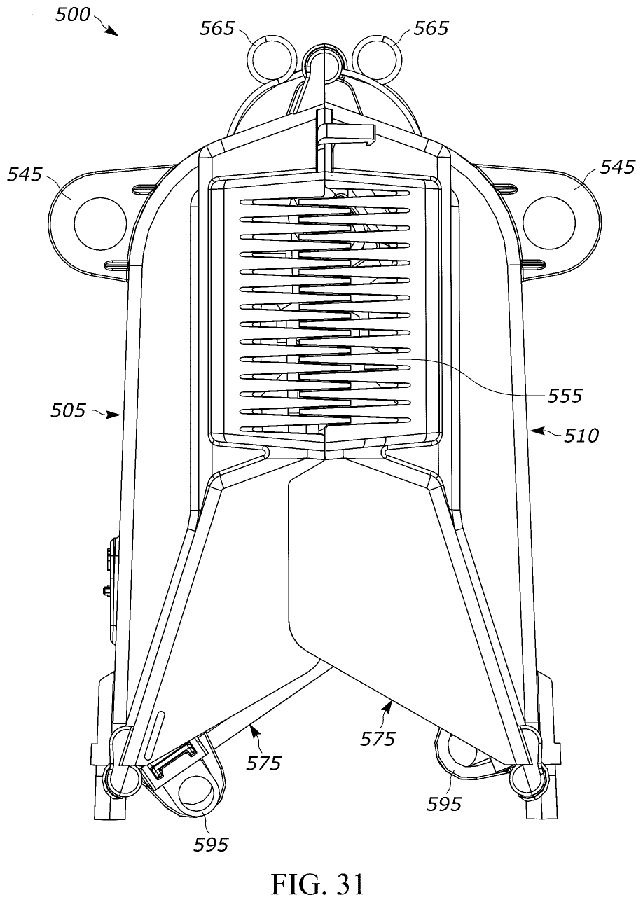

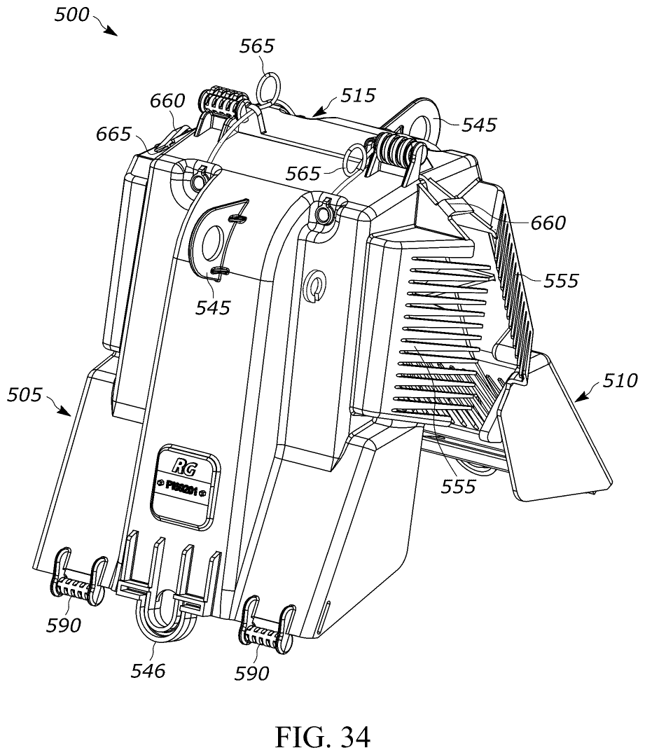

Once connected, the first body 505 and the second body 510 may be pivotable relative to one another. For example, FIGS. 29 to 33 may illustrate a closed position and FIG. 34 may illustrate an open position. Each of the bodies 505, 510 may include a cavity 560. In the closed position, at least one edge of the first body 505 may be in contact with an edge of the second body 510 (see e.g., FIG. 31). The cavities 560 may be facing one another and at least partially enclosed within the clamp guard 500 thereby forming a clamp volume. In the open position, at least one of the bodies (e.g., the first body 505) pivots relative to the other body (e.g., the second body 510). In this open position, each cavity 560 may be at least partially exposed and there is no volume enclosed by the combination of the bodies 505, 510.

As shown in FIGS. 29 to 32, each of the first and second bodies 505, 510 may include a stop 660, which may be formed proximate to the upper end 515. In the illustrated example, each stop 660 may be formed as a cantilever member with a fixed end coupled to the respective body 505, 510. Each stop 660 may extend away from its body 505, 510 and toward the other body 510, 505.

As shown in FIG. 31, the free end of each stop 660 may include a lip or overhang 665. The overhang 665 may be oriented so that it faces inwardly toward the surface of the other body 505, 510.

In the closed position, the plurality of fingers 555 on either side on one body (e.g., the first body 505) may interlace with the plurality of fingers 555 on the respective side of the other body (e.g., the second body 510). The interlaced fingers 555 may provide a barrier that at least partially limits ingress or egress to the volume formed by the cavities 560.

Returning to FIG. 29, the bodies 505, 510 may be biased toward the closed position. For example, at least one biasing member 565 (e.g., two springs shown) may be used to apply a bias to the first and second bodies 505, 510. The illustrated biasing member 565 may be different than the biasing member 365 in FIG. 15. For example, the biasing member 565 may be spaced apart from the connection features 525, 530. The biasing member 565.

As one body 505, 510 moves relative to the other body 510, 505, the spring 565 is compressed (e.g., because the body 505 contacts and moves the free end). In the open position of FIG. 34, the first body 505 may be held in the open position against the spring bias (e.g., by a technician's hand) and the spring force is directed back toward the closed position. When the force counteracting the spring bias is released, the first body 505 may return toward the closed position.

In some forms, a gate 575 may connect to each body 505, 510 proximate to the lower end and may at least partially close the lower end to further enclose the volume within the bodies 505, 510 in the closed position. Each gate 575 may include a body 580 with a plurality of fingers 585 extending away from the body 580. The illustrated body 580 may be a substantially planar member, although other examples may have different thicknesses or surface contours. The plurality of fingers 585 may be formed as cantilever members with a fixed end connected to the body 580 and a free end extending away from the body 580. In some forms, each finger 585 may be tapered from the respective fixed end toward the free end (e.g., to permit interlacing of the fingers 585), although the fingers 585 may be any shape.

Each gate 575 may also include at least one connection feature 590 (e.g., two shown) that extends from the body 580 (e.g., in an opposite direction from the plurality of fingers 585). The connection features 590 may be formed as a hook or C-shaped member. The connection features 590 of the respective gate 575 may connect to the connection rods 550. In the illustrated example, this may be a removable (e.g., snap-fit) connection, although the connection may be a permanent connection in other examples.

The connection features 590 may allow for pivoting movement about the connection rods 590. This pivoting movement may permit a technician to change the position of the gates 575. Specifically, this may permit access into the cavities 560 formed when the bodies 505, 510 are in the closed position.

In certain forms, each of the gates 575 may include a loop 595 (see e.g., FIG. 31). A tool (not show) may hook into the loop 595 and assist in adjusting the position of the respective gate 575. However, the gates 575 may also be manually moveable (e.g., without use of the tool).

In some forms, the gates 575 may be moveable between a closed position and an open position. The gates 575 are moved into the respective cavities 560, although in other examples, the gates 575 may be pulled out of the cavities 560. In either case, the fingers 585 on one gate 575 may not intersect with the fingers 585 on the other gate 575. This may provide substantially unobstructed access into the cavities 560 when the bodies 505, 510 are in the closed position.

In some forms, each gate 575 may include a latch 600. The latch 600 may be formed at an end of the gate 575 (e.g., spaced apart from the fingers 585). In the illustrated example, the latch 600 may include a hook shape with a first portion 605 and a second portion 610 inclined relative to the first portion 605 (e.g., inclined between about 45° and about 100°). The latch 600 may include an undercut 615 along the second portion 610.

In some forms, a complementary latch 620 may be included within the cavities 560. In the illustrated complementary latch 620 is coupled to an internal surface of the respective body 505, 510. However, in other examples, the complementary latch 420 may be included on an opposite side of the gate 575 from the latch 600.

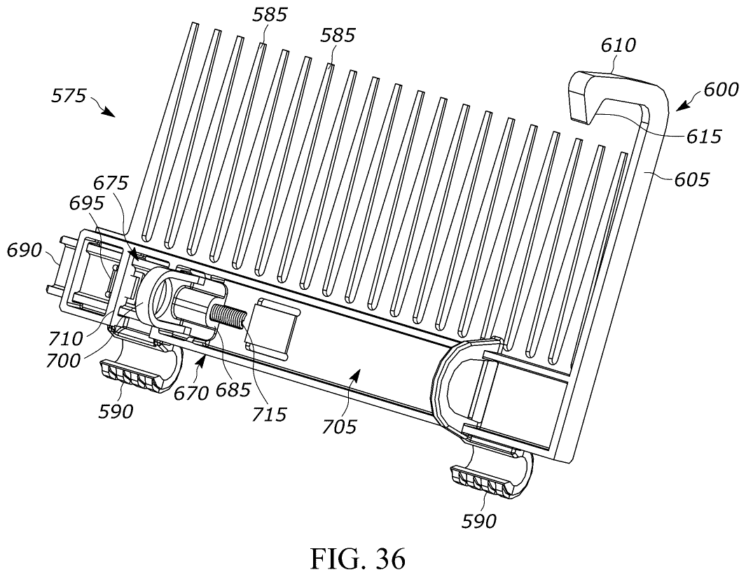

As shown in FIGS. 36 to 42, each gate 575 may further include a latching mechanism 670, which can be used to retain the respective gate 575 is a desired position. As described in more detail below, the latching mechanism 670 may include a lock 675 that can selectively secure the gate 575.

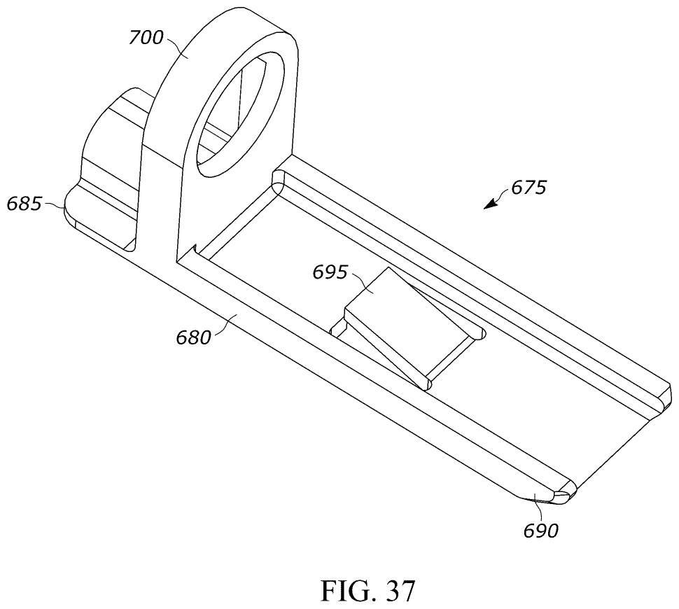

As shown in FIG. 37, the lock 675 may include an elongated body 680 that extends between a first end 685 and a second end 690. The body 680 may have a substantially rectangular profile, although other examples may have different shapes.

In some forms, the lock 675 may include a projection 695, which may be formed between the first and second ends 685, 690. The illustrated projection 695 may be formed as an inclined or ramped member. For example, the projection 695 may smaller thickness proximate to the second end 690 than proximate to the first end 685.

In some forms, the lock 675 may include an opening 700, which may extend from the body 680 and may be disposed between the first and second ends 685, 690. For example, the opening 700 may be disposed between the first end 685 and the projection 695, although other examples may be disposed in a different position.

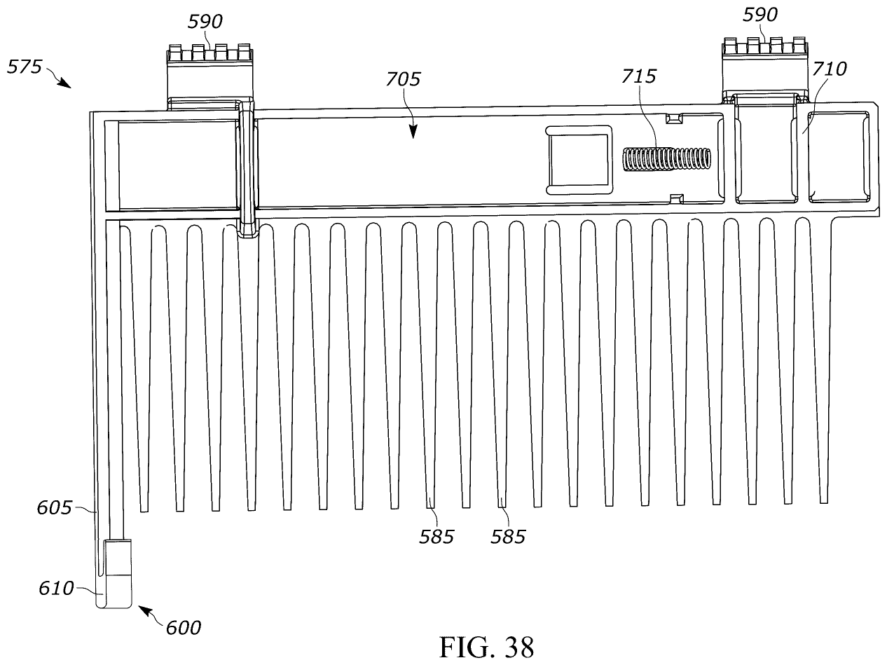

As shown in FIG. 38, a channel 705 may be formed along a base of the gate 575. The fingers 585 may be formed with a fixed end proximate to the channel 705. The channel 705 may extend along a direction substantially perpendicular to the fingers 585.

In some forms, a gate 710 may be positioned over a portion of the channel 705. As described in more detail below, the gate 710 may include an opening that permits the lock 675 to pass through.

In some forms, a biasing member 715 (e.g., a coil spring) may be disposed within the channel 705. The biasing member 715 may connect to the lock 675 to bias the lock 675 in a particular direction.

In use, the guard 500 may be installed around an electrical component (e.g., connected to a conductor). The guard 500 may begin in the open position (see e.g., FIG. 34). As described above, the first body 505 may pivot relative to the second body 510 against the bias of the spring 565. A technician may use a tool (e.g., a hot stick-not shown) to pull the first body 505 by either of the openings 545, 546 relative to the second body 310. While in this open position, the guard 500 may be positioned at least partially around a component. For example, the cavity 560 of the second body 510 may at least partially receive the component.

In some forms, the overhangs 665 on the stops 660 may limit the relative movement between the bodies 505, 510. For example, the overhang 665 on one stop 660 may contact a portion of the other body 505, 510 as the guard 500 moves toward the open position. As shown in FIG. 34, engagement between the stops 660 and the opposite bodies 505, 510 may limit the angular travel of the guard 500. The length of the stops 660 may be designed to permit the guard 500 to open a sufficient amount so that it can receive an electrical component. By defining the maximum angular distance of the open position, the stops 660 may help to limit yielding of the springs 565 that occurs when the bodies 505, 510 are rotated beyond a sufficient distance to receive the electrical component. Limiting the movement of the guard 500 may help to extend the life of the springs 565 (e.g., by increasing the number of cycles before failure).

Once the second body 510 is properly positioned, the technician may release the first body 505 (e.g., by disconnecting the tool from the opening 545, 546). The torsion spring 565 may bias the first body 505 back toward the second body 510. In some forms, the bias in the torsion spring 565 may cause the first body 505 to return to the second body 510. As the first body 505 returns to the closed position (see e.g., FIGS. 29 to 33), the cavity 560 of the first body 505 may at least partially receive the component, and the volume formed by the cavities 560 may fully receive the component. The walls of the bodies 505, 510 may at least partially protect the component.

In some forms, the latch 600 and complementary latch 620 may engage with one another. For example, the latch 600 on one gate 575 may engage the complementary latch 620 in the other body 505, 510. Specifically, the undercut 615 may engage the complementary latch 620 (e.g., with a snap fit). When engaged, the gates 575 may be unable to move relative to one another. Additionally, the bodies 505, 510 may be unable to move relative to one another. Thus, the engagement between the latch 600 and the complementary latch 620 may secure the bodies in the closed position.

As shown in FIG. 41, the biasing member 715 may bias the lock 675 toward an end of the channel 705. In this position, the second end 690 of the lock 675 may project beyond the end of the channel 705 (e.g., and beyond an end of the gate 575). In this position, the second end 690 of the channel 705 may act as a stop to limit the movement of the gate 575 into the cavity 560 of the respective body 505, 510.

In some forms, the biasing force of the biasing member 715 may cause the projection 695 of the lock 675 to pass through the gate 710. This may limit the lock 675 from inadvertently moving in the opposite direction along the channel 705. For example, the maximum height of the projection 695 may be greater than the height of the opening in the gate 710.

A technician may then decouple the latch 600 from the complementary latch 620 by moving the latch 600 relative to the complementary latch 620. For example, the technician (e.g., by hand or using a tool) may be able to move an end of the latch 600 to decouple the latch 600 (e.g., so that the undercut 615 is decoupled from the complementary latch 620). Once this occurs, the gates 575 and the bodies 505, 510 may be movable relative to one another respectively.

In some forms, each finger 555 may be movable independent of the other fingers 555. For example, only fingers 555 in contact with the conductor may move away from the illustrated neutral position, while the remaining fingers 555 may remain in the neutral position. This may permit the fingers 555 to continue to substantially limit other elements from entering the cavities 560.

In the closed position, the guard 500 may act as a barrier to limit access to the component housed inside. For example, the solid bodies 505, 510 may limit climbing or flying wildlife (e.g., squirrels, birds, etc.) from reaching the component. The guard 500 may also limit some contaminants (e.g., animal waste) from reaching the component. In regions where the bodies 505, 510 are not completely solid (e.g., the sides proximate to the fingers 515 and the bottom proximate to the gates 575), the fingers 555, 585 biased to the interlaced neutral position may provide a barrier to wildlife ingress while still permitting the egress of one or more conductors.

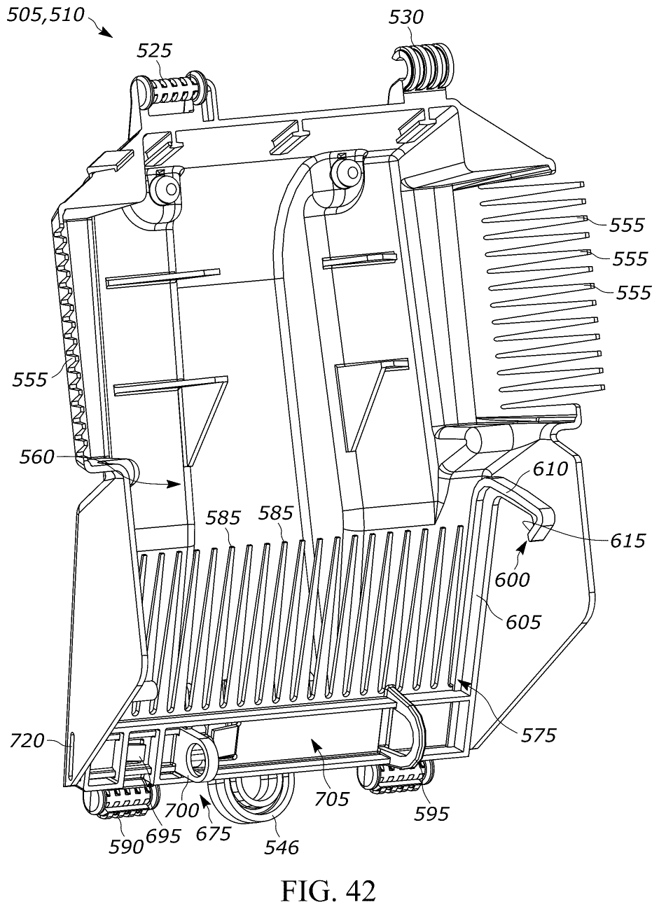

As shown in FIGS. 41 and 42, once the latch 600 is released, the gates 575 may be moved (e.g., pivoted) while the bodies 505, 510 are in the closed position. In the illustrated example, the gates 575 may be pivoted into the respective cavity 560 so that the fingers 585 are not interlaced and an entrance into the cavities 560 through the lower end of the guard 500 is accessible.

In some forms, the technician may manually move the lock 675 along the channel 705 to permit the respective gate 575 to move into the respective cavity 560. For example, the technician may depress the projection 695 so that its maximum height is less than the height of the opening in the gate 710. The technician can then move the lock 675 against the biasing force of the biasing member 715 (e.g., by connecting a tool to the opening 700), thereby moving the second end 690 of the lock 675 into the channel 705 and providing clearance for the gate 575 to move into the respective body 505, 510.

As shown in FIG. 42, the lock 675 may engage the respective body 505, 510 so that the gate 575 is retained within the respective cavity 560 in the opened position. For example, each body 505, 510 may include a slot 720 sized and shaped to receive the second end 690 of the lock 675. The biasing member 715 may cause the lock 675 to return toward its initial position with the second end 690 extending beyond the channel 705 and received within the slot 720. While within the slot 720, the gate 575 may be prevented from returning to the closed position. The technician can similarly move the lock 675 against the biasing force of the biasing member 715 to move the gate 575.

In some forms, a technician may pivot one or more of the gates 575 while the guard 500 is enclosing the component. For example, the technician may move the gate 575 by hand or the technician may use a tool to move the gate 575 (e.g., via the exposed loop 595). When the gate(s) 575 are pivoted to the open position, the technician may access the component (and anything else within the volume) without having to move the guard 500 to the open position.

In some forms, the guard 500 may include a shield 650. As illustrated in FIG. 35, the shield 650 may be disposed within the cavities 560 proximate to the upper end 515 of the guard 500. The shield 650 may be positioned proximate to a seam between the first and second bodies 505, 510. The illustrated shield 450 is connected to the second body 510, although in other examples, the shield may be connected to the first body 505. Because the shield 550 may be attached to only one body 505, 510, it may not limit movement of the bodies 505, 510 between the open and closed positions.

In use, the shield 650 may limit the ingress of fluids into the cavities 560. For example, the shield 650 may limit precipitation and/or bird droppings from entering the cavities 560 and damaging the component. Some forms of the shield 650 may form a seal in the closed position although other forms may simply form a barrier.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A clamp guard for securing an electrical component, the clamp guard comprising:
a first body having a first lower end and a first internal cavity for at least partially receiving the electrical component;
a second body movably coupled to the first body and having a second lower end and a second internal cavity for at least partially receiving the electrical component;
a biasing member connected between the first body and the second body;
a first gate coupled to the first body proximate to the first lower end; and
wherein the second body is movable relative to the first body against a bias of the biasing member between a closed position where the second lower end is adjacent to the first lower end and the first internal cavity and the second internal cavity form a volume, and an open position where the second lower end is spaced apart from the first lower end; and
wherein the first gate is movable coupled to the first body proximate to the first lower end, the first gate configured to move between a first gate position that limits access to the first internal cavity and a second gate position that permits access to the first internal cavity.

2. The clamp guard of claim 1, wherein the first gate includes a plurality of fingers that extend from a body, and wherein the fingers in the plurality of fingers are formed as cantilever members.

3. The clamp guard of claim 1, further comprising a second gate coupled to the second body proximate to the second lower end, wherein the second gate is movable coupled to the second body proximate to the second lower end, the second gate configured to move between a third gate position that limits access to the second internal cavity and a fourth gate position that permits access to the second internal cavity, wherein the first gate includes a first latch and the second gate includes a second latch, wherein the first housing includes a first complementary latch and the second housing includes a second complementary latch, wherein the first latch is configured to engage the second complementary latch and the second latch is configured to engage the first complementary latch, and wherein engagement of the first latch to the second latch is configured to limit movement of the second body relative to the first body.

4. (canceled)

5. The clamp guard of claim 1, further comprising a second gate coupled to the second body proximate to the second lower end, wherein the second gate is movable coupled to the second body proximate to the second lower end, the second gate configured to move between a third gate position that limits access to the second internal cavity and a fourth gate position that permits access to the second internal cavity, wherein the first gate includes a first latch and the second gate includes a second latch configured to mate with the first latch, and wherein engagement of the first latch to the second latch is configured to limit movement of the second body relative to the first body.

6. The clamp guard of claim 1, wherein the biasing member is a torsion spring, wherein the first body includes a first body latch and the second body includes a second body latch, and wherein the bias from the spring is configured to cause the first body latch to engage the second body latch when the second housing returns to the closed position.

7. The clamp guard of claim 1, wherein the first housing includes first fingers and the second housing includes second fingers, wherein the first fingers are configured to interlace with the second fingers in the closed position and limit access into the volume, and wherein the first fingers are spaced apart from the second fingers in the open position.

8. The clamp guard of claim 7, wherein the first fingers and the second fingers are formed from a flexible material, and wherein the first fingers and the second fingers are configured to flex to permit egress of electrical components.

9. A clamp guard for securing an electrical component, the clamp guard comprising:
a first body having a first lower end and a first internal cavity for at least partially receiving the electrical component;
a second body movably coupled to the first body and having a second lower end and a second internal cavity for at least partially receiving the electrical component;
a first gate coupled to the first body proximate to the first lower end;
a second gate coupled to the second body proximate to the second lower end; and
wherein the second body is movable relative to the first body between a closed position where the second lower end is adjacent to the first lower end and the first internal cavity and the second internal cavity form a volume, and an open position where the second lower end is spaced apart from the first lower end;
wherein the first gate is movable coupled to the first body proximate to the first lower end, the first gate configured to move between a first gate position that limits access to the first internal cavity and a second gate position that permits access to the first internal cavity; and
wherein the second gate is movable coupled to the second body proximate to the second lower end, the second gate configured to move between a third gate position that limits access to the second internal cavity and a fourth gate position that permits access to the second internal cavity.

10. The clamp guard of claim 9, wherein the first gate is received within the first internal cavity in the second gate position and wherein the second gate is received within the second internal cavity in the fourth gate position.

11. The clamp guard of claim 9, wherein the first gate includes a first plurality of fingers and the second gate includes a second plurality of fingers, wherein the first plurality of fingers and the second plurality of fingers are interlaced in the closed position and are spaced apart in the open position, wherein the first plurality of fingers and the second plurality of fingers are formed as cantilever members that taper toward a free end, wherein the first plurality of fingers and the second plurality of fingers are formed from a flexible material, and wherein the first plurality of fingers and the second plurality of fingers are configured to flex to permit egress of electrical components.

12. (canceled)

13. (canceled)

14. The clamp guard of claim 9, wherein the first gate includes a first loop that extends away from the first internal cavity in the closed position, wherein the first loop is configured to receive a tool to move the first gate between the first gate position and the second gate position.

15. The clamp guard of claim 9, wherein the first body includes a first connector and the second body includes a second connector configured to connect to the first connector and permit pivotable movement between the first body and the second body, and wherein a biasing member is coupled to a projection of the first connector and is configured to bias the first body and the second body toward the closed position.

16. The clamp guard of claim 9, wherein the first gate includes a first latch and the second gate includes a second latch, wherein the first housing includes a first complementary latch and the second housing includes a second complementary latch, wherein the first latch is configured to engage the second complementary latch and the second latch is configured to engage the first complementary latch, and wherein engagement of the first latch to the second latch is configured to limit movement of the second body relative to the first body.

17.-30. (canceled)

31. A clamp guard for securing an electrical component, the clamp guard comprising:
a first body having a first lower end and a first internal cavity for at least partially receiving the electrical component;
a second body movably coupled to the first body and having a second lower end and a second internal cavity for at least partially receiving the electrical component;
a first gate coupled to the first body proximate to the first lower end, wherein the first gate includes a lock movable relative to the first gate between a first lock position and a second lock position;
wherein the second body is movable relative to the first body between a closed position where the second lower end is adjacent to the first lower end and the first internal cavity and the second internal cavity form a volume, and an open position where the second lower end is spaced apart from the first lower end;
wherein the first gate is movable coupled to the first body proximate to the first lower end, the first gate configured to move between a first gate position that limits access to the first internal cavity and a second gate position that permits access to the first internal cavity; and
wherein the lock is engaged with the first body in the first lock position to limit movement of the first gate between the first gate position and the second gate position.

32. The clamp guard of claim 31, wherein the lock includes an elongated body that extends between a first end and a second end, wherein the second end of the lock is configured to extend beyond an outer edge of the first gate in the first lock position to engage the first body.

33. The clamp guard of claim 32, wherein the lock includes a lock projection disposed between the first end and the second end, wherein the lock projection is formed as a ramped member with a greater height proximate to the first end, wherein the gate further includes an entrance gate, and wherein the lock projection is configured to move through the entrance gate in a first direction and is limited from moving through the entrance gate in a second direction opposite to the first direction.

34. The clamp guard of claim 31, wherein the first gate further includes a spring coupled to the lock and configured to bias the lock toward the first lock position.

35. The clamp guard of claim 31, wherein the first body includes a slot, and wherein the second end of the lock is receive within the slot when the gate is in the second gate position and the lock is in the first lock position.

36. The clamp guard of claim 31, wherein the first gate includes a first loop that extends away from the first internal cavity in the closed position, wherein the first loop is configured to receive a tool to move the first gate between the first gate position and the second gate position.

37. The clamp guard of claim 31, wherein the first body includes a first connector and the second body includes a second connector configured to connect to the first connector and permit pivotable movement between the first body and the second body, and wherein a biasing member is coupled between the first body and the second body and is configured to bias the first body and the second body toward the closed position.

38.-40. (canceled)
